(19) United States
(12) Patent Application Publication
(10) Pub. No.: US 2024/0081410 A1
(43) Pub. Date: Mar. 14, 2024

(54) AEROSOL PROVISION DEVICE

(71) Applicant: NICOVENTURES TRADING LIMITED, London (GB)

(72) Inventors: Ross CABOT, London (GB); Matthew HODGSON, London (GB); Patrick MOLONEY, London (GB); Luke WARREN, London (GB); Anton KORUS, Derbyshire (GB)

(21) Appl. No.: 18/263,927

(22) PCT Filed: Feb. 10, 2022
(86) PCT No.: PCT/EP2022/053290

§ 371 Date: Aug. 2, 2023

(30) Foreign Application Priority Data
Feb. 10, 2021 (GB) 2101840.3
Oct. 7, 2021 (GB) 2114385.4

(51) Int. Cl. A24F 40/465; H05B 6/10

(52) U.S. Cl. CPC A24F 40/465; H05B 6/108

(57) ABSTRACT

An aerosol provision device is disclosed and can include an aerosol generator having a layered inductor arrangement, wherein the layered inductor arrangement includes a plurality of layers optionally three or more layers.

### PRIORITY CLAIM

The present application is a National Phase entry of PCT Application No. PCT/EP2022/053290, filed Feb. 10, 2022, which claims priority from GB Application No. 2101840.3, filed Feb. 10, 2021, which claims priority from GB Application No. 2114385.4, filed Oct. 7, 2021, each of which is hereby fully incorporated herein by reference.

### TECHNICAL FIELD

The present disclosure relates to an aerosol provision device, an aerosol provision system, a method of generating an aerosol and a method of making an aerosol provision device.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use induction heating systems as heaters to create an aerosol from a suitable medium. An induction heating system generally consists of a magnetic field generating device for generating a varying magnetic field, and a susceptor or heating material which is heatable by penetration with the varying magnetic field to heat the suitable medium.

One of the problems with conventional inductor arrangements is that the geometries of the inductor coils are relatively fixed.

It is desired to provide an improved aerosol provision device.

### SUMMARY

According to an aspect there is provided an aerosol provision device comprising: an aerosol generator having a layered inductor arrangement, wherein the layered inductor arrangement comprises a plurality of layers, optionally three or more layers.

The aerosol provision device according to various embodiments results in the ability to produce more flexible designs.

In particular by utilizing a multi-layered arrangement using a PCB the spacing between tracks on different layers can be varied and different materials can be used for traces on each layer.

The various designs of inductors also results in an improvement in inductance by, for example, using a PCB arrangement.

Optionally, the layered inductor arrangement comprises one or more electrically-conductive elements, each electrically-conductive element comprising: a first layer comprising an electrically-conductive first portion; a second layer comprising an electrically-conductive second portion, wherein the second layer is spaced from the first layer along a first direction by a first spacing; and a third layer comprising an electrically-conductive third portion, wherein the third layer that is spaced from the second layer along a second direction by a second spacing.

Optionally, each layered inductor arrangement comprises: a first electrically-conductive connector that electrically connects the first portion to the second portion; and a second electrically-conductive connector that electrically connects the second portion to the third portion.

Optionally, the first layer is coincident with a first plane, the second layer is coincident with a second plane, and the third layer is coincident with a third plane.

Optionally, at least one of the first plane, the second plane, and the third plane are flat planes, and optionally the first direction is perpendicular to the first plane and/or the second direction is perpendicular to the second plane.

Optionally, the first, second, and third planes are parallel flat planes.

Optionally, the second direction along which the third layer is spaced from the second layer is at an angle other than 180 degrees relative to the first direction along which the second layer is spaced from the first layer such that the layered inductor arrangement comprises a staggered structure formed from the first, second, and third portions.

Optionally, the second direction along which the third layer is spaced from the second layer is in a substantially opposite direction to the first direction along which the second layer is spaced from the first layer such that the layered inductor arrangement comprises a staggered structure formed from the first, second, and third portions.

Optionally, the first spacing and the second spacing have equal lengths.

Alternatively, the first spacing and the second spacing have different lengths.

Optionally, at least one of the first portion, the second portion, and the third portions comprise:
a spiral; an irregular spiral; an annulus; a partial spiral; a partial irregular spiral; a partial annulus; a non-spiral; or combinations thereof.

Optionally, the spiral, the irregular spiral, the partial spiral, the partial irregular spiral, the partial annulus, or combinations thereof comprise a tail or vias.

Optionally, the first portion defines at least a first partial turn about a first point on the first plane; and/or the second portion defines at least a second partial turn about a second point on the second plane; and/or the third portion defines at least a third partial turn about a third point on the third plane.

Optionally, the first partial turn, and/or the second partial turn, and/or a third partial turn comprise less than one full turn. Optionally, the first partial turn, and/or the second partial turn, and/or a third partial turn comprise more than one full turn.

Optionally, the first point and the second point lie on a first axis coincident with the first direction, and/or wherein the second point and the third point lie on a second axis coincident with the second direction.

Optionally, the partial spiral comprises a part of: (i) a circular or ovular spiral; (ii) a square or rectangular spiral; (iii) a trapezoidal spiral; or (iv) a triangular spiral.

Optionally, the spiral comprises: (i) a circular or ovular spiral; (ii) a square or rectangular spiral; (iii) a trapezoidal spiral; or (iv) a triangular spiral.

Optionally, the annulus comprises: (i) a circle or oval; (ii) a square or rectangle; (iii) a trapezoid; (iv) a triangle; (v) regular polygon; or (vi) irregular polygon.

Optionally, the partial annulus comprises a part of: (i) a circle or oval; (ii) a square or rectangle; (iii) a trapezoid; (iv) a triangle; (v) regular polygon; or (vi) irregular polygon.

Optionally, the first layer and the third layer are coincident with the same plane. Optionally, the first layer and the third layer are different regions of the same layer.

Optionally, one of the first portion and the third portion are positioned radially inside of the other of the first portion and the third portion.

Optionally, at least one of the first portion and the third portion at least partially overlap the second portion when viewed from a perspective face-on to the layers.

Optionally, the aerosol provision device comprises one or more tracks comprising magnetic material, wherein the one or more tracks are located within the staggered structure.

Optionally, the magnetic material comprises ferrite.

Optionally, the one or more electrically conductive elements comprise further spaced-apart layers comprising respective electrically-conductive portions.

Optionally, the layered inductor arrangement comprises a plurality of mandrel loops, the plurality of mandrel loops being arranged in a multiple layer configuration.

Optionally, the mandrel loops comprise single turn coils. Optionally, the mandrel loops comprises four turn coils.

Optionally, the layered inductor arrangement comprises layers disposed on a printed circuit board (PCB).

Optionally, the layered inductor arrangement comprises layers formed by: (i) laser direct structuring; (ii) laser active plating; and/or (iii) sinter ceramics.

Optionally, the plurality of mandrel loops are arranged in a multiple layer configuration comprising a four layer PCB.

Optionally, the four layer PCB comprises: a first adjacent pair of layers; and a second adjacent pair of layers; wherein the first adjacent pair of layers are closely spaced and the second adjacent pair of layers are farther spaced.

Optionally, closely spaced comprises a distance of 2 mm or less, and wherein farther spaced comprises a distance of greater than 2 mm.

Optionally, each electrically-conductive portion has a thickness, measured in a direction orthogonal to the respective plane, of between 10 micrometers and 200 micrometers.

Optionally, the planes are non-planar or not flat.

According to another aspect there is provided an aerosol provision device comprising: an aerosol generator having a layered inductor arrangement, wherein the layered inductor arrangement comprises: two or more layers; and a bifilar coil.

Optionally, the bifilar coil comprises a first and second concentric inductor, wherein a first layer comprises the first concentric inductor and a second layer comprises the second concentric inductor.

Optionally, the bifilar coil comprises an electrically-conductive linking portion, the electrically-conductive linking portion connecting the first and second concentric inductors.

Optionally, the layered inductor arrangement comprises: three or more layers, wherein each layer comprises a concentric inductor; and a plurality of electrically-conductive linking portions.

According to another aspect there is provided an aerosol provision device comprising: an aerosol generator having a trapezoid shaped inductor arrangement.

Optionally, the trapezoid shaped inductor arrangement comprises an electrically-conducting track, the electrically-conducting track forming an inductor coil in a substantially trapezoidal shape, wherein the substantially trapezoidal shape comprises: a first angled side; a second angled side; a long side; and a short side shorter in length than the long side.

Optionally, each angled side has an angle with respect to the shorter side falling within the range selected from the group comprising: (i)<100°; (ii) 100-120°; (iii) 120-140°; (iv) 140-16°; and (v) 160-180°.

Optionally, the first angled side has a first angle with respect to the shorter side and the second angled side has a second angle with respect to the shorter side, wherein the first angle and the second angle are substantially equal.

Optionally, the first angled side has a first angle with respect to the shorter side and the second angled side has a second angle with respect to the shorter side, wherein the first angle and the second angle are substantially not equal.

Optionally, the first angled side is equal in length to the second angled side.

Optionally, the first angled side is different in length to the second angled side.

Optionally, the long side is curved.

Optionally, the curved long side comprises an arc or portion of a circle.

Optionally, the first angled side, the second angled side, and the long side each have a length falling within the range selected from the group comprising: (i)<5 mm; (ii) 5-7.5 mm; (iii) 7.5-10 mm; (iv) 10-12.5 mm; (v) 12.5-15 mm; (vi) 15-17.5 mm; or (vii) 17.5-20 mm; and the short side has a length falling within the range selected from the group comprising: (i)<2.5 mm; (ii) 2.5-5 mm; (iii) 5-7.5 mm; (iv) 7.5-10 mm.

Optionally, the inductor coil comprises 4.5 turns, and the electrically-conducting track of inductor coil has a width falling within the range 0.65-0.75 mm. Optionally, the inductor coil comprises 5.5 turns, and the electrically-conducting track of inductor coil has a width falling within the range 0.45-0.55 mm.

Optionally, the electrically-conducting track of the inductor coil comprises a gap between adjacent portions or turns of the electrically-conducting track, the gap having a length falling within the range selected from the group comprising: (i)<0.2 mm; (ii) 0.2-0.4 mm; (iii) 0.4-0.6 mm; (iv) 0.6-0.8 mm; or (v) 0.8-1.0 mm.

Optionally, the gap between adjacent portions or turns of the electrically-conducting track comprises a varying gap.

Optionally, the inductor arrangement comprises a track density of the electrically-conducting track, wherein the track density is variable across the substantially trapezoidal shape.

Optionally, the substantially trapezoidal shape comprises a center and a perimeter, and wherein track density is greater towards the center of the trapezoidal shape as compared to the perimeter.

Optionally, the aerosol generator comprises one or more inductor arrangements, wherein the one or more inductor arrangements are arranged to generate a varying magnetic field and wherein one or more susceptors are arranged to become heated by the varying magnetic field.

According to another aspect there is provided an aerosol provision system comprising: an aerosol provision device as described above; and an article for use with an aerosol provision device.

Optionally, the article includes one or more susceptor elements.

Optionally, the article is inserted, in use, into the aerosol provision device so that at least a portion of one of the one or more susceptor elements are located in close proximity to at least a portion of the one or more inductor arrangements.

Optionally, the article comprises aerosol generating material.

Optionally, the aerosol generating material is provided: (i) as a solid; (ii) as a liquid; (iii) in the form of a gel; (iv) in the form of a thin film substrate; (v) in the form of a thin film substrate having multiple regions; or (vi) in the form of a thin film substrate having multiple regions, wherein at least two of the regions comprise aerosol generating material having different compositions.

According to another aspect there is provided a method of generating an aerosol comprising: providing an aerosol provision device as described above; inserting an article comprising aerosol generating material into the aerosol provision device; and energizing the aerosol generator.

According to another aspect there is provided a method of making an aerosol provision device comprising: providing an aerosol generator having a layered inductor arrangement, wherein the layered inductor arrangement comprises a plurality of layers, optionally three or more layers.

According to another aspect there is provided a method of making an aerosol provision device comprising: providing an aerosol generator having a layered inductor arrangement, wherein the layered inductor arrangement comprises: two or more layers; and a bifilar coil.

According to another aspect there is provided a method of making an aerosol provision device comprising: providing an aerosol generator having a trapezoid shaped inductor arrangement.

According to another aspect there is provided an aerosol provision device comprising: an aerosol generator having a layered inductor arrangement, wherein the layered inductor arrangement comprises: a first layer comprising an electrically-conductive first portion; a second layer comprising an electrically-conductive second portion; and optionally a third or further layer comprising an electrically-conductive third or further portion.

Optionally, the electrically-conductive first portion comprises a circular spiral.

Optionally, the electrically-conductive second portion comprises a circular spiral.

Optionally, the electrically-conductive third or further portion comprises a circular spiral.

### BRIEF DESCRIPTION OF THE DRAWINGS

Various embodiments will now be described, by way of example only, and with reference to the accompanying drawings, in which:

FIG. 1 shows a schematic side view of an example of an aerosol provision system.

FIG. 2 is a flow diagram showing an example of a method of heating aerosol generating material.

FIG. 3 is a flow diagram showing another example of a method of heating aerosol generating material.

FIG. 4 shows a layered inductor arrangement according to an embodiment.

FIG. 5 shows a schematic perspective view of an electrically-conductive portion comprising a planar non-spiral coil which is the form of a mandrel loop, formed onto a PCB according to an arrangement.

FIG. 6 shows a layered inductor arrangement according to an embodiment comprising four layers.

FIG. 7 shows an exemplary inductor coil arrangement.

FIG. 8 shows a flat inductor bifilar coil according to an arrangement.

FIG. 9 shows a layered inductor arrangement according to an embodiment.

FIG. 10 shows a trapezoid shaped inductor arrangement according to an embodiment.

FIG. 11 shows a regular trapezoid shape inductor arrangement according to an embodiment.

FIG. 12 shows a trapezoid shaped inductor arrangement according to an embodiment comprising a plurality of layers.

FIG. 13 shows a trapezoid shaped inductor arrangement comprising two layers according to another embodiment.

FIG. 14 shows a schematic representation of an example induction heating circuit for the aerosol provision device of FIG. 1.

FIG. 15A shows a schematic representation of a current through an inductor of the example induction heating circuit of FIG. 14 and FIG. 15B shows a schematic representation of a voltage across a current sense resistor of the example induction heating circuit of FIG. 14.

FIG. 16 shows a schematic representation of a voltage across a switching arrangement of the circuit of FIG. 14.

FIG. 17A shows an inductor bifilar ribbon coil according to an arrangement and FIG. 17B shows an edge-on view of the inductor bifilar ribbon coil of FIG. 17A.

FIG. 18A shows a plan view of a planar aerosol generating article according to an arrangement, FIG. 18B shows an end-on view of the aerosol generating article and shows a plurality of susceptors embedded into the aerosol generating article and FIG. 18C shows a side view of the aerosol generating article and shows a plurality of susceptors embedded into the aerosol generating article.

### DETAILED DESCRIPTION OF THE DRAWINGS

As used herein, the term “aerosolizable material” or aerosol generating material includes materials that provide volatilized components upon heating, typically in the form of vapor or an aerosol. “Aerosolizable material” may be a non-tobacco-containing material or a tobacco-containing material. “Aerosolizable material” may, for example, include one or more of tobacco per se, tobacco derivatives, expanded tobacco, reconstituted tobacco, tobacco extract, homogenized tobacco or tobacco substitutes. The aerosolizable material can be in the form of ground tobacco, cut rag tobacco, extruded tobacco, reconstituted tobacco, reconstituted aerosolizable material, liquid, gel, gelled sheet, powder, or agglomerates, or the like. “Aerosolizable material” also may include other, non-tobacco, products, which, depending on the product, may or may not contain nicotine. “Aerosolizable material” may comprise one or more humectants, such as glycerol or propylene glycol.

As used herein, the term “sheet” denotes an element having a width and length substantially greater than a thickness thereof. The sheet may be a strip, for example.

As used herein, the term “heating material” or “heater material” refers to material that is heatable by penetration with a varying magnetic field.

Induction heating is a process in which an electrically-conductive object is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents. Therefore, when such eddy currents are generated in the object, their flow against the electrical resistance of the object causes the object to be heated. This process is called Joule, ohmic, or resistive heating. An object that is capable of being inductively heated is known as a susceptor.

In one example, the susceptor is in the form of a closed circuit. It has been found that, when the susceptor is in the form of a closed electrical circuit, magnetic coupling between the susceptor and the electromagnet in use is enhanced, which results in greater or improved Joule heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule and magnetic hysteresis heating.

In each of the above processes, as heat is generated inside the object itself, rather than by an external heat source by heat conduction, a rapid temperature rise in the object and more uniform heat distribution can be achieved, particularly through selection of suitable object material and geometry, and suitable varying magnetic field magnitude and orientation relative to the object. Moreover, as induction heating and magnetic hysteresis heating do not require a physical connection to be provided between the source of the varying magnetic field and the object, design freedom and control over the heating profile may be greater, and cost may be lower.

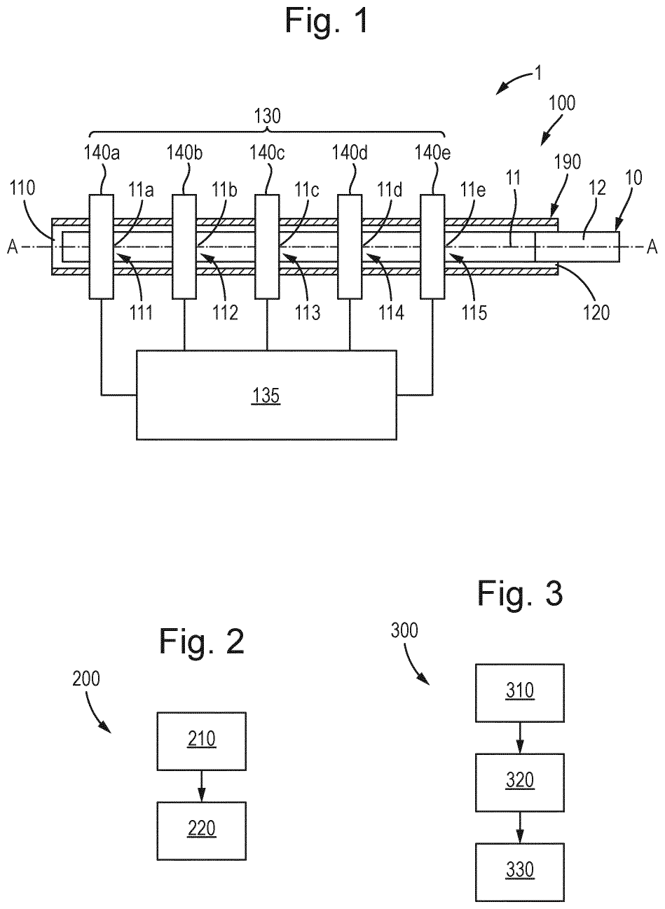

Referring to FIG. 1, there is shown a schematic cross-sectional side view of an example of an aerosol provision system 1. The aerosol provision system 1 comprises an aerosol provision device 100 and an article 10 comprising aerosol generating material 11. The aerosol generating material 11 may, for example, be of any of the types of aerosol generating material discussed herein. In this example, the aerosol provision device 100 is a tobacco heating product (also known in the art as a tobacco heating device or a heat-not-burn device).

The aerosol generating material 11 may comprise a non-liquid material. In some examples, the aerosol generating material 11 is a gel. In some examples, the aerosol generating material 11 comprises tobacco. However, in other examples, the aerosol generating material 11 may consist of tobacco, may consist substantially entirely of tobacco, may comprise tobacco and aerosol generating material other than tobacco, may comprise aerosol generating material other than tobacco, or may be free from tobacco. In some examples, the aerosol generating material 11 may comprise a vapor or aerosol forming agent or a humectant, such as glycerol, propylene glycol, triacetin, or diethylene glycol. In some examples, the aerosol generating material 11 comprises reconstituted aerosol generating material, such as reconstituted tobacco.

The aerosol generating material 11 may be substantially cylindrical with a substantially circular cross section and a longitudinal axis. In other examples, the aerosol generating material 11 may have a different cross-sectional shape and/or not be elongate.

The aerosol generating material 11 of the article 10 may, for example, have an axial length of between 8 mm and 120 mm. For example, the axial length of the aerosol generating material 11 may be greater than 9 mm, or 10 mm, or 15 mm, or 20 mm. For example, the axial length of the aerosol generating material 11 may be less than 100 mm, or 75 mm, or 50 mm, or 40 mm.

In some examples, such as that shown in FIG. 1, the article 10 comprises a filter arrangement 12 for filtering aerosol or vapor released from the aerosol generating material 11 in use. Alternatively, or additionally, the filter arrangement 12 may be for controlling the pressure drop over a length of the article 10. The filter arrangement 12 may comprise one, or more than one, filter. The filter arrangement 12 could be of any type used in the tobacco industry. For example, the filter may be made of cellulose acetate. In some examples, the filter arrangement 12 is substantially cylindrical with a substantially circular cross section and a longitudinal axis. In other examples, the filter arrangement 12 may have a different cross-sectional shape and/or not be elongate.

The article 10 may also comprise a wrapper (not shown) that is wrapped around the aerosol generating material 11 and the filter arrangement 12 to retain the filter arrangement 12 relative to the aerosol generating material 11. The wrapper may be wrapped around the aerosol generating material 11 and the filter arrangement 12 so that free ends of the wrapper overlap each other. The wrapper may form part of, or all of, a circumferential outer surface of the article 10. The wrapper could be made of any suitable material, such as paper, card, or reconstituted aerosol generating material (e.g. reconstituted tobacco).

The aerosol provision device 100 comprises a heating zone 110 for receiving at least a portion of the article 10, an outlet 120 through which aerosol is deliverable from the heating zone 110 to a user in use, and an aerosol generator 130 for causing heating of the article 10 when the article 10 is at least partially located within the heating zone 110 to thereby generate the aerosol. In some examples, such as that shown in FIG. 1, the aerosol is deliverable from the heating zone 110 to the user through the article 10 itself, rather than through any gap adjacent to the article 10. Nevertheless, in such examples, the aerosol still passes through the outlet 120, albeit while travelling within the article 10.

In this example, the heating zone 110 extends along an axis A-A and is sized and shaped to accommodate only a portion of the article 10. In this example, the axis A-A is a central axis of the heating zone 110. Moreover, in this example, the heating zone 110 is elongate and so the axis A-A is a longitudinal axis A-A of the heating zone 110. The article 10 is insertable at least partially into the heating zone 110 via the outlet 120 and protrudes from the heating zone 110 and through the outlet 120 in use. In other examples, the heating zone 110 may be elongate or non-elongate and dimensioned to receive the whole of the article 10. In some such examples, the aerosol provision device 100 may include a mouthpiece that can be arranged to cover the outlet 120 and through which the aerosol can be drawn from the heating zone 110 and the article 10.

In this example, when the article 10 is at least partially located within the heating zone 110, different portions 11a-11e of the aerosol generating material 11 are located at different respective locations 111-115 in the heating zone 110. In this example, these locations 111-115 are at different respective axial positions along the axis A-A of the heating zone 110. Moreover, in this example, since the heating zone 110 is elongate, the locations 111-115 can be considered to be at different longitudinally-spaced-apart positions along the length of the heating zone 110. In this example, the article 10 can be considered to comprise five such portions 11a-11e of the aerosol generating material 11 that are located respectively at a first location 111, a second location 112, a third location 113, a fourth location 114 and a fifth location 115.

The aerosol generator 130 may comprise one or more heating units 140a-140e, each of which is able to cause heating of a respective one of the portions 11a-11e of the aerosol generating material 11 to a temperature sufficient to aerosolize a component thereof, when the article 10 is at least partially located within the heating zone 110. The heating units 140a-140e may be axially-aligned with each other along the axis A-A. Each of the portions 11a-11e of the aerosol generating material 11 heatable in this way may, for example, have a length in the direction of the axis A-A of between 1 millimeter and 20 millimeters, such as between 2 millimeters and 10 millimeters, between 3 millimeters and 8 millimeters, or between 4 millimeters and 6 millimeters.

The aerosol generator 130 of this example comprises five heating units 140a-140e, namely: a first heating unit 140a, a second heating unit 140b, a third heating unit 140c, a fourth heating unit 140d and a fifth heating unit 140e. The heating units 140a-140e are at different respective axial positions along the axis A-A of the heating zone 110. Moreover, in this example, since the heating zone 110 is elongate, the heating units 140a-140e can be considered to be at different longitudinally-spaced-apart positions along the length of the heating zone 110. In other examples, the aerosol generator 130 could comprise more than five heating units 140a-140e or fewer than five heating units, such as only four, only three, only two, or only one heating unit. The number of portion(s) of the aerosol generating material 11 that are heatable by the respective heating unit(s) may be correspondingly varied.

The aerosol generator 130 may further comprise a controller 135 that is configured to cause operation of the heating units 140a-140e to cause the heating of the respective portions 11a-11e of the aerosol generating material 11 in use. In this example, the controller 135 is configured to cause operation of the heating units 140a-140e independently of each other, so that the respective portions 11a-11e of the aerosol generating material 11 can be heated independently. This may be desirable in order to provide progressive heating of the aerosol generating material 11 in use.

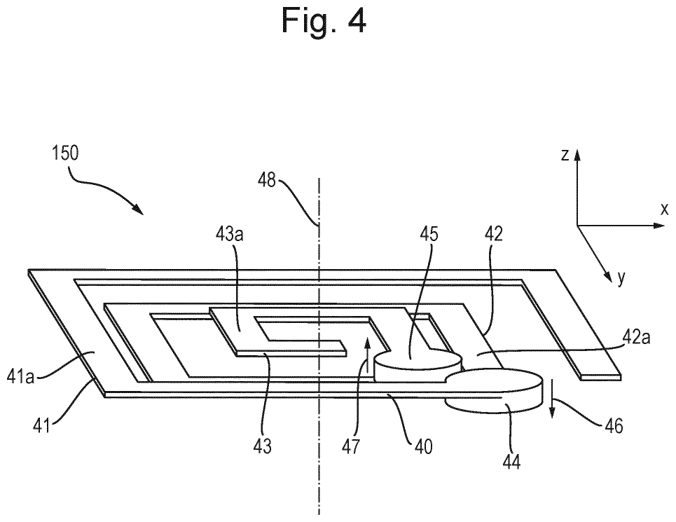

In this example, the heating units 140a-140e comprise respective induction heating units that are configured to generate respective varying magnetic fields, such as alternating magnetic fields. As such, the aerosol generator 130 can be considered to comprise a magnetic field generator, and the controller 135 can be considered to be apparatus that is operable to pass a varying electrical current through inductors of the respective heating units 140a-140e. The inductors of the respective heating units 140a-140e may comprise any one or more of the inductor arrangements as described below, such as any one or more of the inductor arrangement 150, 60, 90, 1000, 1100, 1200, 1300 arrangements shown in FIGS. 4, 6, and 9-13. Moreover, in this example, the aerosol provision device 100 comprises a susceptor 190 that is configured so as to be heatable by penetration with the varying magnetic fields to thereby cause heating of the heating zone 110 and the article 10 therein in use. That is, portions of the susceptor 190 are heatable by penetration with the respective varying magnetic fields to thereby cause heating of the respective portions 11a-11e of the aerosol generating material 11 at the respective locations 110a-110e in the heating zone 110.

In some examples, the susceptor 190 is made of, or comprises, aluminum. However, in other examples, the susceptor 190 may comprise one or more materials selected from the group consisting of: an electrically-conductive material, a magnetic material, and a magnetic electrically-conductive material. In some examples, the susceptor 190 may comprise a metal or a metal alloy. In some examples, the susceptor 190 may comprise one or more materials selected from the group consisting of: aluminum, gold, iron, nickel, cobalt, conductive carbon, graphite, steel, plain-carbon steel, mild steel, stainless steel, ferritic stainless steel, molybdenum, silicon carbide, copper, and bronze. Other material(s) may be used in other examples.

In some examples, such as those in which the susceptor 190 comprises iron, such as steel (e.g. mild steel or stainless steel) or aluminum, the susceptor 190 may comprise a coating to help avoid corrosion or oxidation of the susceptor 190 in use. Such coating may, for example, comprise nickel plating, gold plating, or a coating of a ceramic or an inert polymer.

In this example, the susceptor 190 is tubular and encircles the heating zone 110. Indeed, in this example, an inner surface of the susceptor 190 partially delimits the heating zone 110. An internal cross-sectional shape of the susceptor 190 may be circular or a different shape, such as elliptical, polygonal or irregular. In other examples, the susceptor 190 may take a different form, such as a non-tubular structure that still partially encircles the heating zone 110, or a protruding structure, such as a rod, pin or blade, that penetrates the heating zone 110. In some examples, the susceptor 190 may be replaced by plural susceptors. Each of the one or more susceptors of the article 10 may take any suitable form, such as a structure (e.g. a metallic foil, such as an aluminum foil) wrapped around or otherwise encircling the aerosol generating material 11, a structure located within the aerosol generating material 11, or a group of particles or other elements mixed with the aerosol generating material 11.

In this example, the aerosol generator 130 comprises an electrical power source (not shown) and a user interface (not shown) for user-operation of the device. The electrical power source of this example is a rechargeable battery. In other examples, the electrical power source may be other than a rechargeable battery, such as a non-rechargeable battery, a capacitor, a battery-capacitor hybrid, or a connection to a mains electricity supply.

In this example, operation of the user interface by a user causes the controller 135 to cause an alternating electrical current to pass through the inductor arrangement 150, 60, 90, 1000, 1100, 1200, 1300 of at least one of the respective heating units 140a-140e. In other examples where there may be more than one inductor arrangement, the secondary coil may be placed between the inductors arrangement such that both inductors arrangement induce a varying electrical current through the secondary coil. However, in other examples where each of the heating units 140a-140e comprise more than one respective inductor arrangement, there may be a respective secondary coil for each respective inductor arrangement, so that each respective inductor arrangement induces a varying electrical current into the respective secondary coil.

Further discussion of the form of each of the heating units 140a-140e will be given below with reference to FIGS. 2 and 3. However, what is notable at this stage is that the size or extent of the varying magnetic fields as measured in the direction of the axis A-A is relatively small, so that the portions of the susceptor 190 that are penetrated by the varying magnetic fields in use are correspondingly small. Accordingly, it may be desirable for the susceptor 190 to have a thermal conductivity that is sufficient to increase the proportion of the susceptor 190 that is heated by thermal conduction as a result of the penetration by the varying magnetic fields, so as to correspondingly increase the proportion of the aerosol generating material 11 that is heated by operation of each of the heating units 140a-140e.

In some examples in which the aerosol generator 130 has more than two heating units, such as the example shown in FIG. 1, during the heating session the aerosol generator 130 may also be configured to cause heating of at least one further portion 11b-11e of the aerosol generating material 11 to a temperature sufficient to aerosolize a component of the further portion 11b-11e of the aerosol generating material 11 before or more quickly than the heating of a still further portion 11c-11e of the aerosol generating material 11 that is fluidly closer to the outlet 120. That is, the controller 135 may be configured to cause suitable operation of the heating units to cause the heating of the at least one further portion 11b-11e of the aerosol generating material 11 before or more quickly than the heating of the still further portion 11c-11e of the aerosol generating material 11. For example, in the device of FIG. 1, the aerosol generator 130 may be configured to cause: (i) heating of the second portion 11b of the aerosol generating material 11 to a temperature sufficient to aerosolize a component of the second portion 11b of the aerosol generating material 11 before or more quickly than the heating of the third portion 11c of the aerosol generating material 11; (ii) heating of the third portion 11c of the aerosol generating material 11 to a temperature sufficient to aerosolize a component of the third portion 11c of the aerosol generating material 11 before or more quickly than the heating of the fourth portion 11d of the aerosol generating material 11; and (iii) heating of the fourth portion 11d of the aerosol generating material 11 to a temperature sufficient to aerosolize a component of the fourth portion 11d of the aerosol generating material 11 before or more quickly than the heating of the fifth portion 11e of the aerosol generating material 11.

It will be understood that, for a given duration of heating session, the greater the number of heating units and associated portions of the aerosol generating material 11 there are, the greater the opportunity to generate aerosol from “fresh” or unspent portions of the aerosol generating material 11 extending along a given axial length. Alternatively, for a given duration of heating each portion of the aerosol generating material 11, the greater the number of heating units and associated portions of the aerosol generating material 11 there are, the longer the heating session may be. It should be appreciated that the duration for which an individual heating unit may be activated can be adjusted (e.g. shortened) to adjust (e.g. reduce) the overall heating session, and at the same time the power supplied to the heating element may be adjusted (e.g. increased) to reach the operational temperature more quickly.

Referring to FIG. 2, there is shown a flow diagram showing an example of a method of heating aerosol generating material during a heating session using an aerosol provision device. The aerosol provision device used in the method 200 comprises a heating zone for receiving at least a portion of an article comprising aerosol generating material, an outlet through which aerosol is deliverable from the heating zone to a user in use, and heating apparatus for causing heating of the article when the article is at least partially located within the heating zone to thereby generate the aerosol. The aerosol provision device may, for example, be that which is shown in FIG. 1 or any of the suitable variants thereof discussed herein.

The method 200 comprises the aerosol generator 130 causing, when the article 10 is at least partially located within the heating zone 110, heating 210 of a first portion 11a of the aerosol generating material 11 of the article 10 to a temperature sufficient to aerosolize a component of the first portion 11a of the aerosol generating material 11 before or more quickly than heating 220 of a second portion 11b of the aerosol generating material 11 of the article 10 to a temperature sufficient to aerosolize a component of the second portion 11b of the aerosol generating material 11, wherein the second portion 11b of the aerosol generating material 11 is fluidly located between the first portion 11a of the aerosol generating material 11 and the outlet 120.

It will be understood from the teaching herein that the method 200 could be suitably adapted to comprise the aerosol generator 130 also causing heating of at least one further portion 11b-11e of the aerosol generating material 11 to a temperature sufficient to aerosolize a component of the further portion 11b-11e of the aerosol generating material 11 before or more quickly than the heating of a still further portion 11c-11e of the aerosol generating material 11 that is fluidly closer to the outlet 120, as discussed above.

Referring to FIG. 3, there is shown a flow diagram showing another example of a method of heating aerosol generating material during a heating session using an aerosol provision device. The aerosol provision device used in the method 300 comprises a heating zone for receiving at least a portion of an article comprising aerosol generating material, an outlet through which aerosol is deliverable from the heating zone to a user in use, and heating apparatus for causing heating of the article when the article is at least partially located within the heating zone to thereby generate the aerosol. The heating apparatus comprises a first heating unit, a second heating unit, a third heating unit and a controller that is configured to cause operation of the first, second and third heating units. The aerosol provision device may, for example, be that which is shown in FIG. 1 or any of the suitable variants thereof discussed herein.

The method 300 comprises the controller 135 controlling the first, second and third heating units 140a,140b,140c independently of each other to cause, when the article 10 is at least partially located within the heating zone 110: the first heating unit 140a to heat 310 a first portion 11a of the aerosol generating material 11 of the article 10 to a temperature sufficient to aerosolize a component of the first portion 11a of the aerosol generating material 11 (e.g. before or more quickly than the second portion 11b); the second heating unit 140b to heat 320 a second portion 11b of the aerosol generating material 11 of the article 10 to a temperature sufficient to aerosolize a component of the second portion 11b of the aerosol generating material 11 (e.g. before or more quickly than the third portion 11c); and the third heating unit 140c to heat 330 a third portion 11c of the aerosol generating material 11 of the article 10 to a temperature sufficient to aerosolize a component of the third portion 11c of the aerosol generating material 11.

When the aerosol provision device used in the method 300 comprises sufficient heating units, it will be understood from the teaching herein that the method 300 could be suitably adapted to comprise the aerosol generator 130 also controlling fourth and fifth heating units 140d, 140e independently of each other to cause, when the article 10 is at least partially located within the heating zone 110: the fourth heating unit 140d to heat a fourth portion 11d of the aerosol generating material 11 of the article 10 to a temperature sufficient to aerosolize a component of the fourth portion 11d of the aerosol generating material 11; and the fifth heating unit 140e to heat a fifth portion 11e of the aerosol generating material 11 of the article 10 to a temperature sufficient to aerosolize a component of the fifth portion 11e of the aerosol generating material 11.

One of the heating units 140a-140e of the aerosol generator 130 will now be described in more detail with reference to FIGS. 4-13, which disclose various features of an inductor arrangement 150, 60, 90, 1000, 1100, 1200, 1300 of the heating unit.

Referring to FIG. 4, it will be understood that inductor arrangement 150 may be a layered inductor arrangement 150. In this example, the layered inductor arrangement 150 includes three layers, namely: a first layer 41; a second layer 42; and a third layer 43. The first layer 41 comprises an electrically-conductive first portion 41a, the second layer 42 comprises an electrically-conductive second portion 42a, and the third layer 43 comprises an electrically-conductive third portion 43a. The second layer 42 may be spaced from the first layer 41 along a first direction given by the arrow 46 by a first spacing. The third layer 43 may be spaced from the second layer 42 along a second direction given by the arrow 47 by a second spacing.

Still referring to FIG. 4, the layered inductor arrangement 150 may form a single electrically-conductive element. For example, the layered inductor arrangement 150 may comprise a first electrically-conductive connector 44 that electrically connects the first portion 41a to the second portion 42a, and a second electrically-conductive connector 45 that electrically connects the second portion 42a to the third portion 43a. In the example of FIG. 4, the first layer 41 is coincident with a first plane, the second layer 42 is coincident with a second plane, and the third layer 43 is coincident with a first plane.

The first, second, and third planes are all depicted as flat parallel planes, for example planes which are parallel to the XY-plane. However, in arrangements, not all of the planes need be flat planes. For example, one of the three planes may be a flat plane, and the remaining planes may be non-flat planes. In arrangements, all of the planes may be non-flat planes. A non-flat plane may be: a curvilinear plane; a plane defined by a surface of revolution; a plane comprising a discontinuity; or combinations thereof. A plane comprising a discontinuity may be a plane having a first portion which is flat or described by a continuous function, and a second portion connected to the first portion such that the first portion is discontinuous with respect to the second portion. For example, a non-flat plane may comprise two flat planes connected together at an angle so as to form an elongated V-shape.

In FIG. 4, the first, second, and third planes are parallel flat planes. Accordingly, the first direction 46 and the second direction 47 are perpendicular to the planes, and are directed in mutually opposing directions. In this way, the layered inductor arrangement comprises a staggered structure formed from the first 41a, second 42a, and third 43a portions. For example, successive portions are spaced from each such that successive portions are staggered with respect to the z-direction. In the arrangement of FIG. 4, the first spacing between the first 41 and second 42 layers and the second spacing between the second 42 and third 43 layers have equal lengths. In this way, the first layer 41 and third layer 43 are coincident with the same plane such that the third portion 43a of the third layer 43 is positioned radially inwards or inside of the first portion 41a of the first layer 41.

It will be understood that the first layer 41 and the third layer 43 may be different regions of the same layer. In arrangements where the first 41 and third 43 layers are different regions of the same layer, inter-portion regions between the first 41a and third 43a portions may comprise: a non-electrically-conductive material as discussed below; or an insulating gas such as air. It is contemplated that the layered inductor arrangement 150 may be fabricated by layering the in-plane first 41 and third 43 layers simultaneously on-top of the second layer 42. In arrangements, fabrication techniques comprise: PCB fabrication techniques, laser direct structuring; laser active plating; and/or sinter ceramics.

In other arrangements, the first spacing and the second spacing have different lengths. In some arrangements, a staggered structure may be formed from the first, second, and third portions of any of the aforementioned arrangements, wherein the second direction 47 may be at angle other than 180 degrees relative to the first direction. In this way, the layered inductor arrangement may comprise any number of complex staggered geometries.

In the arrangement of FIG. 4, each of the first 41a, second 42a, and third 43a portions trace a non-spiral shape, wherein the non-spiral is a square or rectangular non-spiral. Each non-spiral comprises almost one complete turn. For example, each portion may individually comprise a planar non-spiral coil which is in the form of a mandrel loop.

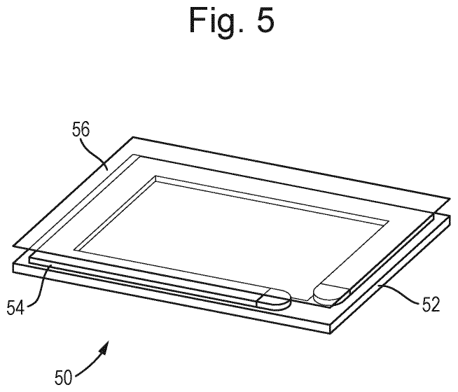

Referring now to FIG. 5, there is shown a schematic perspective view of an electrically-conductive portion 50 comprising a planar non-spiral coil which is the form of a mandrel loop, formed onto a PCB, according to an arrangement. The portion 50 is for use in a layered inductor coil arrangement, such as the one described above in relation to FIG. 4.

The portion 50 comprises a PCB 52, a planar non-spiral inductor coil disposed onto the PCB 52, in the form an of a mandrel loop 54, disposed on top of the mandrel loop 54 is an isolator 56. The mandrel loop is formed of electrically-conductive material, such as copper.

Although this arrangement includes a PCB 52, other arrangements are contemplated wherein the mandrel loop 52 is not disposed onto a PCB. Instead only the mandrel loop 54 is present, or only the mandrel loop 54 and isolator 56 are present. In this particular arrangement, the mandrel loop comprises only a single turn. However, other arrangements are contemplated where the mandrel loop 54 comprises more than one turn e.g. two turns, three turns, four turns or more than four turns.

The isolator 56 of this arrangement is in the form of planar plate. The isolator 56 may be made from a non-electrically-conductive material, such as a plastics material, so as to electrically-insulate the mandrel loop 54. In this arrangement, the isolator 56 is made from FR-4, which is a composite material composed of woven fiberglass cloth with an epoxy resin binder that is flame retardant.

In some examples, when used in a layered inductor arrangement, a plurality of the portions 50 as described above may be used, wherein successive portions 50 are of different sizes. In one example, there would only be a single PCB 52. According to this arrangement, a first mandrel loop 54 is disposed on the PCB 52 and a second mandrel loop 54 is disposed on the PCB 52 within from the first mandrel loop 54. Disposed on the first and second mandrel loops 54 is a first isolator 56. A third mandrel loop 54 may be disposed on the first isolator 56. A first vias may connect one end of the third mandrel loop 54 to the first mandrel loop 54, and a second vias may connect the other end of the third mandrel loop 54 to the second mandrel loop 54. A second isolator 56 may be provided on the second mandrel loop 54. This configuration can be repeated the required amount of times until specific requirements are met e.g. such that a required amount of flux density is achieved when a varying (e.g. alternating) electric current is passed through the layered inductor arrangement formed from the plurality of mandrel loops 54.

In other examples, rather than a single PCB 52, each respective layer may comprise its own PCB 52, mandrel loop 54 and isolator 56. In other examples, no respective PCB's 52 or isolators 56 are present, instead a plurality of mandrel loops 54 are arranged in multiple layers. In such examples, the mandrel loops 54 may be electrically insulated from each other in a different way, such as by an air gap.

Referring now to examples where a PCB 52 is present, the mandrel loop 54 may be affixed to the PCB 52 in any suitable way. In the arrangement illustrated in FIG. 5, the portion 50 has been formed from printed circuit board (PCB) and so the mandrel loop 54 has been formed by printing the electrically-conductive material onto the respective first and second sides, onto the PCB 52 during manufacture of the PCB 52, and then removing (such as by etching) selective portions of the electrically-conductive material so that patterns of the electrically-conductive material in the form of the mandrel loop remain. Accordingly, mandrel loop 54 is a thin film or coating of electrically-conductive material on the PCB 52.

In arrangements, the layered inductor arrangement comprises a four layer PCB 52 as described in any of the above arrangements. The four layer PCB comprises a first adjacent pair of layers and a second adjacent pair of layers, wherein the first adjacent pair of layers are closely spaced and the second adjacent pair of layers are farther spaced. For example, the closely spaced first adjacent pair of layers may be separated by a distance of 2 mm or less, and the farther spaced second adjacent pair of layers may be separated by a distance of greater than 2 mm.

Arrangements wherein the inductor arrangement comprises, or is formed from, a PCB facilitates manufacture of the inductor arrangement and also enables the respective electrically-conductive portions to be thin and closely spaced.

In arrangements, any number of different shapes are contemplated for the electrically-conductive portions.

For example, any one of the electrically-conductive portions may comprise: a spiral; an irregular spiral; an annulus; a partial spiral; a partial irregular spiral; a partial annulus; a non-spiral; or combinations thereof. In arrangements, a partial spiral comprises a part of: (i) a circular or ovular spiral; (ii) a square or rectangular spiral; (iii) a trapezoidal spiral; or (iv) a triangular spiral. In arrangements, a spiral comprises: (i) a circular or ovular spiral; (ii) a square or rectangular spiral; (iii) a trapezoidal spiral; or (iv) a triangular spiral. In arrangements, an annulus comprises: (i) a circle or oval; (ii) a square or rectangle; (iii) a trapezoid; or (iv) a triangle; (v) regular polygon; (vi) irregular polygon. In arrangements, a partial annulus comprises a part of: (i) a circle or oval; (ii) a square or rectangle; (iii) a trapezoid; or (iv) a triangle; (v) regular polygon; (vi) irregular polygon. Any one of the electrically-conductive portions may comprise a tail or vias.

In arrangements, any one of the electrically-conductive portions may define a partial turn, wherein the partial turn may be less than one full turn or greater than one full turn. Each partial turn of each portion may be defined as a turn about the same axis, such as axis 48 in FIG. 4. Alternatively, each portion may trace a partial turn about a point on each respective plane, wherein the points on each respective plane do not lie on a shared axis. For example, two of the portions may trace respective turns about a shared axis, whereas the other portion may trace a turn about a point which does not lie on the shared axis.

In the arrangement of FIG. 4, neither of the first 41 or third 43 portion overlap the second portion 42 when viewed from a perspective face-on to the layers, that is, viewed from along the z-axis. However, in arrangements, at least one of the first portion and the third portion at least partially overlaps the second portion when viewed from a perspective face-on to the layers. It will be understood that this increases track density with respect to the XY-plane. In this way, the magnetic field able to be generated by the layered inductor arrangement can have a greater field strength as compared to an inductor arrangement comprising only a single flat inductor or single flat spiral. This is because the track widths of the electrically-conducting portion are limited. In this way, staggering the inductor arrangement in the z-direction or out-of-plane direction effectively increases the track density while avoiding the aforementioned limitations. However, it will be appreciated that a layered inductor arrangement 150 will still benefit from being conveniently sized so as to facilitate various different positioning of components within the aerosol provision device 100.

The inductor arrangement 150 may comprise support 40, such as that provided by a PCB. One or more layers may be supported by one or more supports by being disposed on the one or more supports, or embedded in (either partially or fully) the one or more supports. In the arrangement of FIG. 4, the third layer 43 is shown disposed on the support 40, with the other two layers being self-supported by the first and second electrically-conductive connectors. However, other arrangements are contemplated wherein more of the layers are supported by further supports, such as all the layers each being disposed or embedded on a respective support. Alternatively, only some of the layers may be supported such that the inductor arrangement comprises one or more supports. For example, each of the supported layers may be disposed on or embedded in a respective support, or a single support may be configured such that two or more layers are supported by the same single support, or combinations thereof. In yet other arrangements, the inductor arrangement 150 comprises no support(s). It will be understood that the one or more supports can be made of any suitable electrically-insulating material(s). In some examples, the support 140 comprises a matrix (such as an epoxy resin, optionally with added filler such as ceramics) and a reinforcement structure (such as a woven or non-woven material, such as glass fibers or paper).

The electrically-conductive portions 41a-43a and electrically-conductive connectors 44,45 can be made of any suitable electrically-conductive material(s). In some examples, the portions 41a-43a and connectors 44,45 are made of copper. In arrangements wherein the inductor arrangement 150 comprises one or more supports 40, the electrically-conductive connectors 44,45 may take the form of a “via” that extends through the one or more supports 40. Even in examples in which the inductor arrangement 150 is not formed from a PCB, the connectors 44,45 still may extend through the one or more supports 40.

In arrangements, one or more tracks comprising magnetic material may be located within the staggered structure. The magnetic material may be ferromagnetic or ferrimagnetic. For example, the magnetic material may of a hard ferromagnetic material, a hard ferrimagnetic material, a soft ferromagnetic material, or a soft ferrimagnetic material, wherein hard or soft corresponds to high or low coercive fields, respectively. The magnetic material may for example comprise ferrite or magnetite.

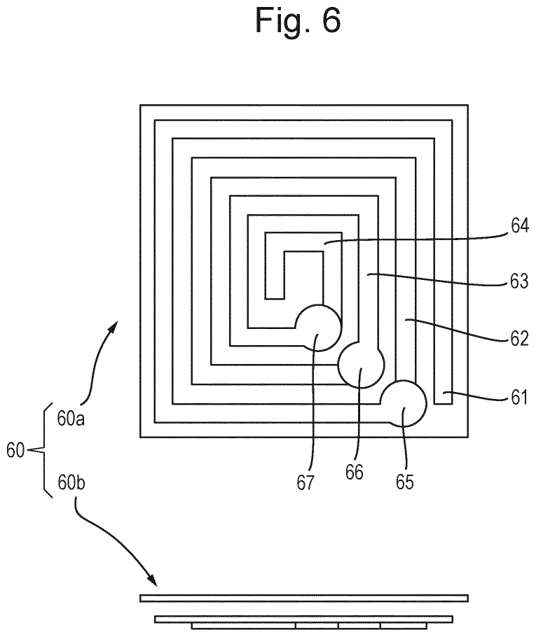

It will be understood that the above described layered inductor arrangement may be formed from an electrically-conductive element comprising any number of further spaced-apart layers comprising respective electrically-conductive portions. In arrangements, the layered inductor arrangement may comprise between four and six layers, or between seven and nine layers, or greater than ten layers. For example, FIG. 6 shows a layered inductor arrangement 60 comprising four layers 61-64 from a face-on perspective 60a and from a side-on perspective 60b. In FIG. 6, the respective electrically-conductive connectors 65,66,67 are not shown in the side-on perspective 60b for reasons of clarity. In the arrangement of FIG. 6, the spacings between successive layers are not equal, such that at least three of the layers are each coincident with a different plane, as can be seen from the side-on perspective 60b. Accordingly, the extent to which successive layers of the layered inductor arrangement are staggered and spaced with respect to one another provides an additional parameter by which the form of an induced magnetic field induced by the layered inductor arrangement may be tuned. As a consequence, the heat concentration induced by the magnetic field in a nearby susceptor (such as susceptor 190 in FIG. 1) can be selectively tuned by suitable design of the staggered structure of the layered inductor arrangement 150.

In arrangements, spacings between successive spaced-apart layers may have a distance falling within the range selected from the group comprising: (i)<0.5 mm; (ii) 0.5-2.0 mm; (iii) 2.0-4.0 mm; and (v)>4.0 mm. With reference to FIG. 4, in examples comprising one or more supports, the one or more supports 40 may have a thickness of about 0.85 mm. In some examples, the one or more supports 40 may have a thickness other than 0.85 millimeters, such as another thickness lying in the range of 0.2 millimeters to 2 millimeters. For example, each of the thicknesses may be between 0.5 millimeters and 1 millimeter, or between 0.75 millimeters and 0.95 millimeters. In some examples, the one or more supports 40 may comprise a plurality of supports 40, and the thicknesses of the respective supports 40 are equal to each other, or substantially equal to each other. In other examples, one or more of the supports 40 may have a thickness that differs from a thickness of one or more of the other supports 40.

In arrangements, each of the portions 41a-43a of the layered inductor arrangement 150 has a thickness, measured in a direction orthogonal to each respective plane, of about 142 micrometers. In some examples, one or more of the portions 41a-43a may have a thickness other than 142 micrometers, such as another thickness lying in the range of 10 micrometers to 200 micrometers. For example, each of the thicknesses may be between 25 micrometers and 175 micrometers, or between 100 micrometers and 150 micrometers.

In examples in which the layer inductor arrangement 150 is made from a PCB, the thickness of the material of the layer inductor arrangement 150 may be determined by “plating-up” the material on a substrate, prior to construction of the PCB. Some standard circuit boards have a 1 oz layer of electrically-conductive material, such as copper, on the substrate. A 1 oz layer has a thickness of about 38 micrometers. By plating-up to a 4 oz layer, the thickness is increased to about 142 micrometers. Increasing the thickness makes the structure of the inductor arrangement more robust and reduces system losses due to a commensurate reduction in ohmic losses. Increasing the volume of material of the layer inductor arrangement 150 will increase the heat capacity of the layer inductor arrangement 150, reducing the temperature gain for a given input of heat. This may be beneficial, as it can be used to help ensure that the temperature of the layer inductor arrangement 150 itself in use does not get so high as to cause damage to the structure of the layer inductor arrangement 150. In some examples, the thicknesses of the respective portions 41a-43a of the layered inductor arrangement 150 are equal to each other, or substantially equal to each other. This can lead to a more consistent heating effect being produced by the different portions of the layered inductor arrangement 150. In other examples, one or more of the portions 41a-43a of the layered inductor arrangement 150 may have a thickness that differs from a thickness of one or more of the other portions 41a-43a of the layered inductor arrangement 150. This may be intentional in some examples, so as to provide an increased heating effect produced by certain portion(s) of the layered inductor arrangement 150 as compared to the heating effect produced by other portion(s) of the layered inductor arrangement 150.

The layered inductor arrangement 150 of these arrangements enables a higher track density within a single inductor coil arrangement

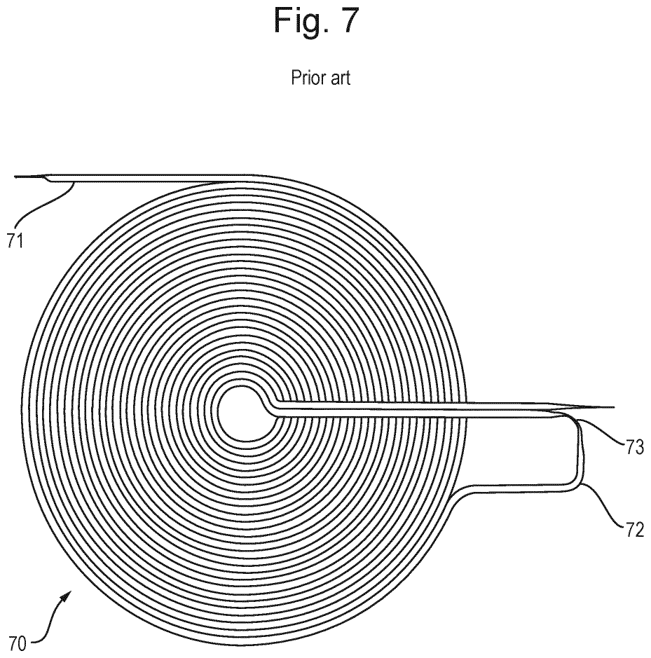

Referring to FIG. 7, there is shown an exemplary inductor coil arrangement 70, which is a so-called Tesla flat inductor bifilar coil 70. The inductor coil arrangement 70 contains a first winding or coil 71 and a second winding or coil 72 which is closely spaced and parallel with the first winding 71. The two windings are bonded by an electrically conducting linking portion 73, such that current flow through the two windings is maintained in the same direction. The skilled person would understand that coupling the two windings together in this way improves the performance of the inductor coil arrangement 70, as the current is flowing in the same direction such that there is substantially no induced magnetic field cancellation. Moreover, the skilled person would understand that there is a capacitive linking of the wires, and, in the circular-shaped arrangement, the link connection is very small such that there is a low phase shift between the wires.

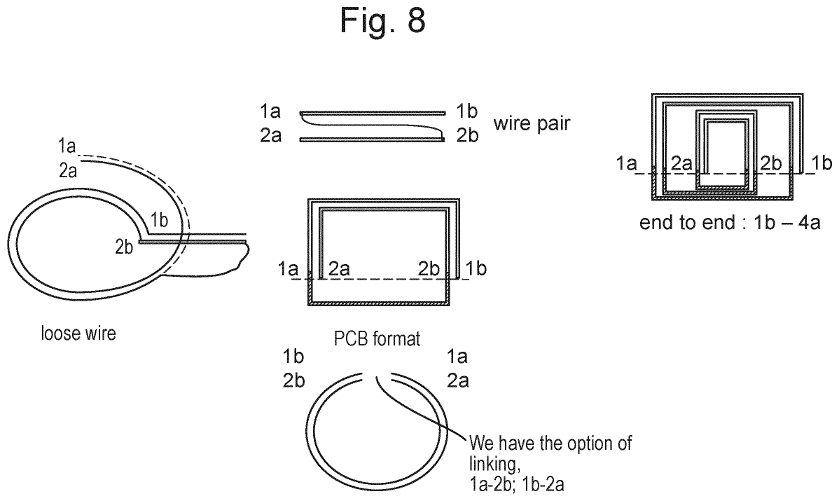

As shown schematically in FIG. 8, the flat inductor bifilar coil 80 naturally maps to a spiral. By adding an additional pair of wires, a larger spiral may be formed.

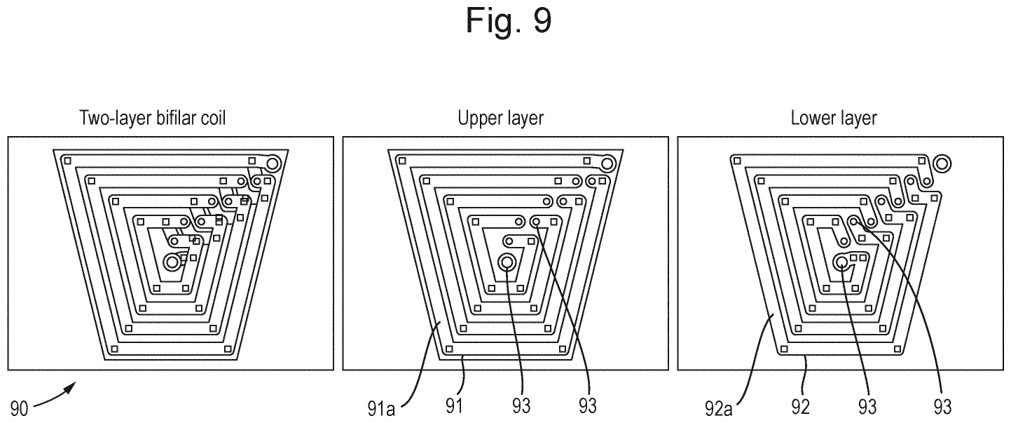

Accordingly, it has been found that the bifilar coil can be mimicked by exploiting the out-of-plane dimension. Referring to FIG. 9, there is shown an arrangement of a layered inductor arrangement 90, wherein the layered inductor arrangement 90 is a two-layer bifilar coil inductor arrangement 90 comprising a first layer 91 and a second layer 92. The first layer 91 comprises one or more first electrically-conductive wires or tracks 91a, and the second layer 92 comprises one or more second electrically-conductive wires or tracks 92a. The first 91a and second 92a electrically-conductive wires or tracks may be concentric and substantially over-lapping when viewed from a perspective face-on to the layers, as shown in FIG. 9. One or more electrically-conductive linking portions 93 connect one or more of the first electrically-conductive wires or tracks 91a to the second electrically-conductive wires or tracks 92a. In arrangements, the layered inductor arrangement 90 may be formed in a PCB format, wherein the vertical plane can be used and adding to the already low aspect ratio (height of copper track to width) enhances further the effect. It has been found that coupling the wires or tracks vertically instead of horizontally further enhances the mutual coupling or capacitive linking of the wires, while minimizing the phase shift between them.

It will be understood that the above described layered inductor arrangement comprising a bifilar coil across two layers may be extended to comprise any number of further layers comprising respective concentric inductors and having a plurality of electrically-conductive linking portions. In this way, the advantages of trifler, or greater, inductor arrangements can be exploited by using the unique layered geometry. As will be understood, the above arrangements may be formed in a PCB format, as discussed with reference to FIG. 5.

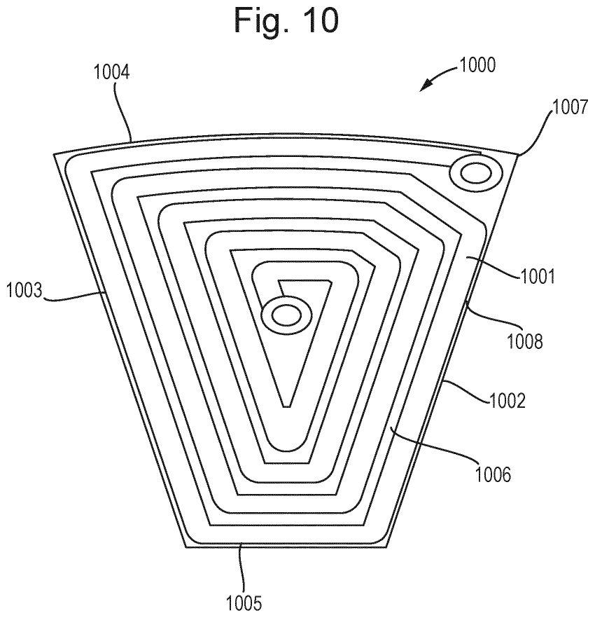

Referring now to FIG. 10, there is shown a trapezoid shaped inductor arrangement 1000 according to an arrangement. The trapezoid shaped inductor arrangement may comprise an electrically-conducting track 1001, for example a copper track. As shown, the electrically-conducting track 1001 may form an inductor coil in a substantially trapezoidal shape, wherein the substantially trapezoidal shape comprises: a first angled side 1002, a second angled side 1003, a long side 1004 and a short side 1005 shorter in length than the long side 1004.

FIG. 10 shows a regular trapezoid shape, wherein the first 1002 and second 1003 angled sides have substantially the same lengths, and substantially the same angle with respect to the short side 1005. For example, as shown in FIG. 10, the angled sides may each be angled at 104 degrees with respect to the short side 1005. However, in other arrangements, each angled side has an angle with respect to the shorter side 1005 falling within the range selected from the group comprising: (i)<100 degrees; (ii) 100-120 degrees; (iii) 120-140 degrees; (iv) 140-160 degrees; and (v) 160-180 degrees.

In other arrangements, the first angled side 1002 has a first angle with respect to the shorter side 1005 and the second angled side 1003 has a second angle with respect to the shorter side 1005, wherein the first angle and the second angle are substantially not equal.

In arrangements, the first angled side 1002 is equal in length to the second angled side 1003. Alternatively, in arrangements, the first angled side 1002 is different in length to the second angled side 1003.

As show in FIG. 10, the long side 1004 may be curved. For example, the curved long side 1004 may comprise an arc or portion of a circle. In the arrangement of FIG. 10, the angle subtending the arc of the long side 1004 is 28 degrees. However, in arrangements, the arc of the long side 1004 may correspond to an angle of less than 28 degrees or more than 28 degrees. In arrangements, it is contemplated that a plurality of trapezoid shaped inductor arrangements 1000 can be positioned adjacent one another such that the long sides 1004 are facing radially outwards and the plurality of long sides 1004 together substantially form a circle. As will be understood, the angle corresponding to the arc of each long side 1004 will depend on the number of trapezoid shaped inductor arrangements 1000 to be fit into a circle. In arrangements, different ones of inductor arrangements 1000 may comprise different arc lengths 1004, such that a circle is formed by adjacent trapezoid shaped inductor arrangements 1000 of different proportions.

In arrangements, the first angled side 1002, the second angled side 1003 and the long side 1004 each have a length falling within the range selected from the group comprising: (i) <5 mm; (ii) 5-7.5 mm; (iii) 7.5-10 mm; (iv) 10-12.5 mm; (v) 12.5-15 mm; (vi) 15-17.5 mm; or (vii) 17.5-20 mm; and the short side 1005 has a length falling within the range selected from the group comprising: (i)<2.5 mm; (ii) 2.5-5 mm; (iii) 5-7.5 mm; (iv) 7.5-10 mm.

In arrangements, the trapezoid shaped inductor arrangements as discussed above can be configured to inductively heat an associated heating area. For example, the associated heating area may comprise one or more susceptors. The associated heating area may be matched to the shape of one or more portions of an article comprising aerosol generating material. For example, an article comprising aerosol generating material may comprise a trapezoid shaped portion, the article being for use with an aerosol provision device having a trapezoid shaped inductor arrangement as described in the above arrangements.

It has been found that the narrower region of the inductor coil, i.e. the region of the inductor coil nearest the short side 1005 of the trapezoid shaped inductor arrangement, induces more heat in the corresponding region of the associated heating area as compared to the wider region of the inductor coil (i.e. nearest the long side 1004). In arrangements, the narrower region of the inductor coil can be positioned furthest away from the mouthpiece of the device. This may be because there is a relatively high coil density in the narrower end than the wider end. An advantage of this is that the space about the narrower region of the inductor coil (where the generated aerosol collects) may be hotter, thus reducing the formation of aerosol-derived condensation in this region.

In the arrangement of FIG. 10, the inductor coil comprises 4.5 turns, wherein a turn is measured from corner to corner. The electrically-conducting track of inductor coil may have a width falling within the range 0.65-0.75 mm, such as 0.70 mm as shown in FIG. 10.

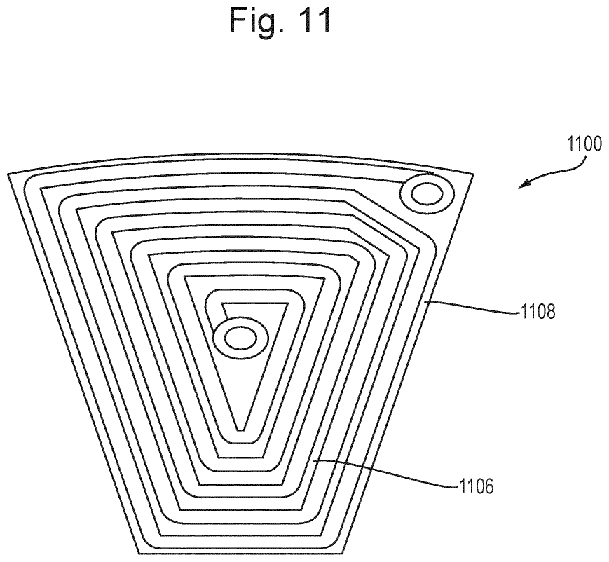

FIG. 11 also shows a regular trapezoid shape inductor arrangement 1100, however the inductor coil in this arrangement comprises 5.5 turns, and the electrically-conducting track of inductor coil has a width falling within the range 0.45-0.55 mm, such as 0.50 mm as shown in FIG. 11.

On the one hand, it has been found that reducing the number of turns means that the track widths can be increased to get an overall lower resistance and a corresponding higher current from a particular set voltage applied across terminals of the inductor coil. On the other hand, a higher number of turns leads to a higher induced magnetic field strength, and a higher efficiency accordingly. The arrangements of FIGS. 10 and 11 provide two designs which balance low resistance and high magnetic field generation efficiency with an optimal number of coils to be used as part of an aerosol provision device.

In arrangements, the electrically-conducting track 1001 of inductor coil comprises a gap 1006 between adjacent portions or turns of the electrically-conducting track 1001. The gap 1006 may have a length falling within the range selected from the group comprising: (i)<0.2 mm; (ii) 0.2-0.4 mm; (iii) 0.4-0.6 mm; (iv) 0.6-0.8 mm; or (v) 0.8-1.0 mm. For example, the arrangement of FIG. 10 comprises a gap of 0.30 mm, whereas the arrangement of FIG. 11 comprises a gap of 0.25 mm. It has been found that these arrangements give a consistent heating induced by the inductor coil arrangement with fewer miscellaneous hot spots in the associated heating area.

In arrangements, the regular trapezoid shape inductor arrangement may comprise one or more supports 1007, as described above in reference to FIG. 4. The one or more supports 1007 may equally be referred to as one or more substrates. As shown in FIG. 10, the support 1007 can have a trapezoid shape as described above, and the shape of inductor coil can conform to the shape of the support 1007. In arrangements, there may be an edge-gap 1008 between the outer-most track 1001 and an edge of the support 1007. For example, the arrangement of FIG. 10 comprises an edge-gap 1008 of 0.15 mm which is different to the gap 1006 between adjacent portions of the track. Alternatively, as shown in the arrangement of FIG. 11, the edge-gap 1108 of 0.25 mm is the same size as the gap 1106 between adjacent portions of the track. In other arrangements, the edge gap may be less than 0.15 mm, in the range 0.15-0.25 mm, or greater than 0.25 mm.

In arrangements, the gap between adjacent portions or turns of the electrically-conducting track comprises a varying gap. In arrangements, the variation of the gap may be configured such that the trapezoid shaped inductor arrangement may induce a substantially uniform inductive coupling across a large portion of one or more susceptors of the associated heating area, or across substantially the entirety of the one or more susceptors. In arrangements, the variation of the gap may be configured such that the trapezoid shaped inductor arrangement may induce a stronger coupling across a first portion of the one or more susceptors compared with a second portion of the one or more susceptor. This may be desirable, more example for tailoring the properties of the aerosol to be generated. For example, aerosol may be generated from an aerosol generating material with a first flavor by using heat from the first portion of the one or more susceptors, an aerosol with a second flavor may be generated by using heat from the second portion of the one or more susceptors.

In arrangements, the inductor arrangement comprises a track density of the electrically-conducting track, wherein the track density is variable across the substantially trapezoidal shape.

For example, the track density may be greater towards the center of the trapezoidal shaped inductor arrangement as compared to the perimeter. In arrangements, this may be desirable so as to increase heat towards the center of one or more susceptors of the associated heating area. Increasing heat towards the center of one or more susceptors may advantageously enable a quicker time from the start of heating to first puff of generated aerosol.

It will be appreciated that the trapezoid shaped inductor arrangement can comprise a layered inductor arrangement as described in any of the aforementioned arrangements. For example, the layered inductor arrangement 90 of FIG. 9, which is a two-layer bifilar coil inductor arrangement 90, is shown as a trapezoid shaped inductor arrangement.

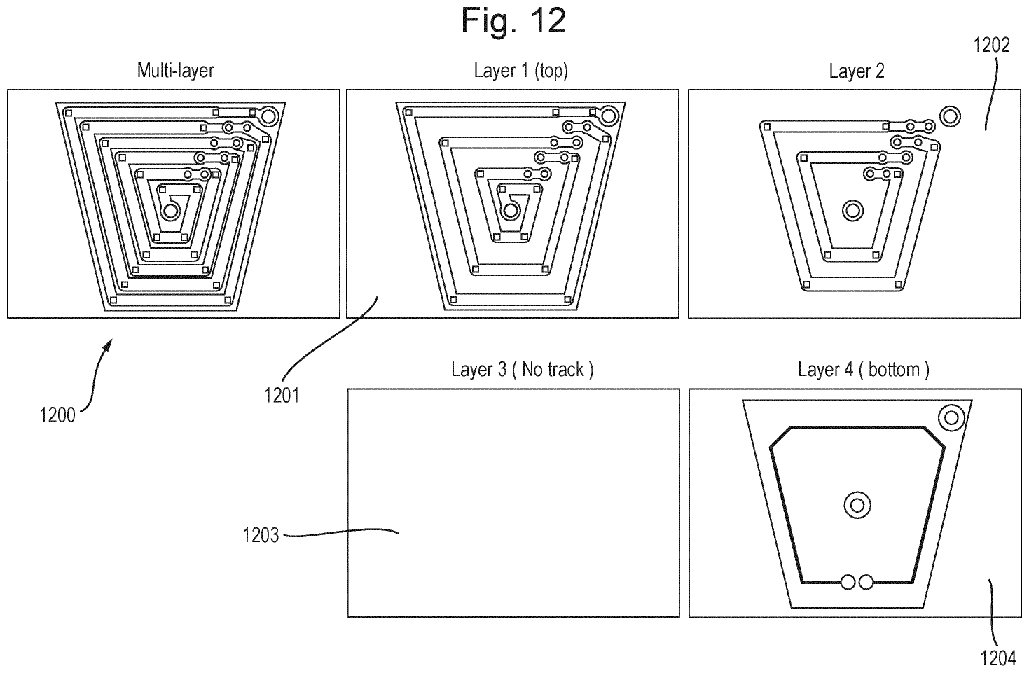

Referring now to FIG. 12, there is shown another trapezoid shaped inductor arrangement 1200 comprising a plurality of layers.

In principle two layers are used which stagger layers in single loops. According to arrangements the layout based on a two layer PCB may now be changed to a four layer so that the bottom layer is now the second layer. It is desired that layer 1 (top) and layer 2 are close together. According to arrangements the following sized vias may be utilized: small (0.787 mm×0.356 mm) and large (1.2 mm×0.75 mm). Small vias can be changed to suit the inline track but clear outer diameter is an issue. It is desired that they handle current but are constrained to fit track width or not interfere with other tracks.

It will be noted that the track width differs slightly on the first and second layers but it is desired that the tracks are symmetrical.

The top layer 1201 may according to arrangements have track widths of 0.635 mm and 0.508 mm in thinner sections where it comes near the vias. Two linking vias may be provided in series. The inline via may be optimized to suit but the aim is for a higher hole diameter.

The second layer 1202 may have track widths of 0.762 mm and 0.508 mm in thinner sections where it comes near the vias. Two linking vias will be required since they must be in series to track and current will be high. The inline via can be optimized to suit track but aim is for higher hole diameter.

The third layer 1203 may comprise no tracks. The fourth layer 1204 may comprise the bottom layer. On this layer a 0.3 mm track may be provided. A sense track may be placed approximately as shown with a 0.3 mm track and two pads may be provided on the end to solder.

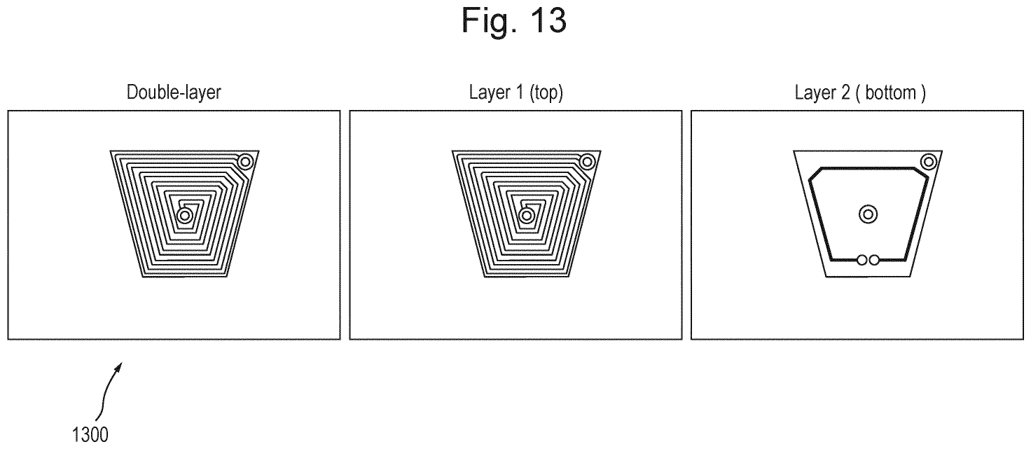

Referring now to FIG. 13, there is shown another trapezoid shaped inductor arrangement 1300 comprising two layers.

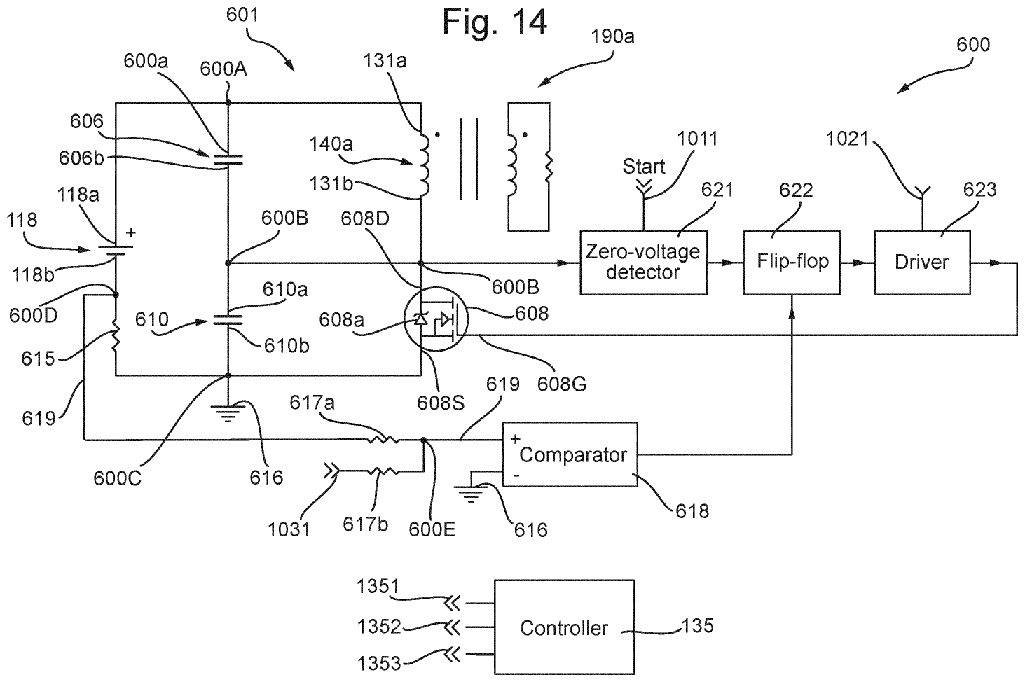

As has been described above in relation to FIG. 1, the heating assembly of the example device 100 may be an inductive heating assembly comprising various components to heat the aerosol generating material of article 10 via an induction heating process. In particular, the inductive heating units or inductor coil arrangements 140a-140e first inductor coil arrangement 140a are used to heat respective portions 190a-190e of the susceptor 190 (or a corresponding plurality of susceptors) to thereby cause heating of the respective portions 11a-11e of the aerosol generating material 11 and generate an aerosol. This applies to both arrangements wherein the aerosol provision device 100 comprises the susceptor (or susceptors) 190 (as shown in FIG. 1) or wherein the article 10 comprises the susceptor 190 (or susceptors). Below, with reference to FIGS. 14 to 16, the operation of the aerosol provision device 100 in using, as an example, a first inductor coil arrangement 140a to inductively heat the corresponding portion of susceptor arrangement will be described in detail.

The inductive heating assembly of the device comprises an LC circuit. An LC circuit, has an inductance L provided by an inductor coil arrangement, and a capacitance C provided by a capacitor. In the device, the inductance L is provided by the inductor coil arrangements 140a-140e and the capacitance C may typically be provided by a plurality of capacitors as will be discussed below. An induction heater circuit comprising an inductance L and a capacitance C may in some cases be represented as an RLC circuit, comprising a resistance R provided by a resistor. In some cases, resistance is provided by the ohmic resistance of parts of the circuit connecting the inductor and the capacitor, and hence the circuit need not necessarily include a resistor as such. Such circuits may exhibit electrical resonance, which occurs at a particular resonant frequency when the imaginary parts of impedances or admittances of circuit elements cancel each other.

One example of an LC circuit is a series circuit where the inductor and capacitor are connected in series. Another example of an LC circuit is a parallel LC circuit where the inductor and capacitor are connected in parallel. Resonance occurs in an LC circuit because the collapsing magnetic field of the inductor generates an electric current in its windings that charges the capacitor, while the discharging capacitor provides an electric current that builds the magnetic field in the inductor. When a parallel LC circuit is driven at the resonant frequency, the dynamic impedance of the circuit is at maximum (as the reactance of the inductor equals the reactance of the capacitor), and circuit current is at a minimum. However, for a parallel LC circuit, the parallel inductor and capacitor loop acts as a current multiplier (effectively multiplying the current within the loop and thus the current passing through the inductor). Allowing the RLC or LC circuit to operate at the resonant frequency for at least some of the time while the circuit is in operation to heat the susceptor may therefore provide for effective and/or efficient inductive heating by providing for the greatest value of the magnetic field penetrating the susceptor.

The LC circuit used by the device to heat the susceptor may make use of one or more transistors acting as a switching arrangement as will be described below. A transistor is a semiconductor device for switching electronic signals. A transistor typically comprises at least three terminals for connection to an electronic circuit. A field effect transistor (FET) is a transistor in which the effect of an applied electric field may be used to vary the effective conductance of the transistor. The field effect transistor may comprise a body, a source terminal S, a drain terminal D, and a gate terminal G. The field effect transistor comprises an active channel comprising a semiconductor through which charge carriers, electrons or holes, may flow between the source S and the drain D. The conductivity of the channel, i.e. the conductivity between the drain D and the source S terminals, is a function of the potential difference between the gate G and source S terminals, for example generated by a potential applied to the gate terminal G. In enhancement mode FETs, the FET may be OFF (i.e. substantially prevent current from passing therethrough) when there is substantially zero gate G to source S voltage, and may be turned ON (i.e. substantially allow current to pass therethrough) when there is a substantially non-zero gate G-source S voltage.

One type of transistor which may be used in circuitry of the aerosol provision device 100 is an n-channel (or n-type) field effect transistor (n-FET). An n-FET is a field effect transistor whose channel comprises an n-type semiconductor, where electrons are the majority carriers and holes are the minority carriers. For example, n-type semiconductors may comprise an intrinsic semiconductor (such as silicon for example) doped with donor impurities (such as phosphorus for example). In n-channel FETs, the drain terminal D is placed at a higher potential than the source terminal S (i.e. there is a positive drain-source voltage, or in other words a negative source-drain voltage). In order to turn an n-channel FET “on” (i.e. to allow current to pass therethrough), a switching potential is applied to the gate terminal G that is higher than the potential at the source terminal S.

Another type of transistor which may be used in the aerosol provision device 100 is a p-channel (or p-type) field effect transistor (p-FET). A p-FET is a field effect transistor whose channel comprises a p-type semiconductor, where holes are the majority carriers and electrons are the minority carriers. For example, p-type semiconductors may comprise an intrinsic semiconductor (such as silicon for example) doped with acceptor impurities (such as boron for example). In p-channel FETs, the source terminal S is placed at a higher potential than the drain terminal D (i.e. there is a negative drain-source voltage, or in other words a positive source-drain voltage). In order to turn a p-channel FET “on” (i.e. to allow current to pass therethrough), a switching potential is applied to the gate terminal G that is lower than the potential at the source terminal S (and which may for example be higher than the potential at the drain terminal D).

In examples, one or more of the FETs used in the aerosol provision device 100 may be a metal-oxide-semiconductor field effect transistor (MOSFET). A MOSFET is a field effect transistor whose gate terminal G is electrically insulated from the semiconductor channel by an insulating layer. In some examples, the gate terminal G may be metal, and the insulating layer may be an oxide (such as silicon dioxide for example), hence “metal-oxide-semiconductor”. However, in other examples, the gate may be made from other materials than metal, such as polysilicon, and/or the insulating layer may be made from other materials than oxide, such as other dielectric materials. Such devices are nonetheless typically referred to as metal-oxide-semiconductor field effect transistors (MOSFETs), and it is to be understood that as used herein the term metal-oxide-semiconductor field effect transistors or MOSFETs is to be interpreted as including such devices.

A MOSFET may be an n-channel (or n-type) MOSFET where the semiconductor is n-type. The n-channel MOSFET (n-MOSFET) may be operated in the same way as described above for the n-channel FET. As another example, a MOSFET may be a p-channel (or p-type) MOSFET, where the semiconductor is p-type. The p-channel MOSFET (p-MOSFET) may be operated in the same way as described above for the p-channel FET. An n-MOSFET typically has a lower source-drain resistance than that of a p-MOSFET. Hence in an “on” state (i.e. where current is passing therethrough), n-MOSFETs generate less heat as compared to p-MOSFETs, and hence may waste less energy in operation than p-MOSFETs. Further, n-MOSFETs typically have shorter switching times (i.e. a characteristic response time from changing the switching potential provided to the gate terminal G to the MOSFET changing whether or not current passes therethrough) as compared to p-MOSFETs. This can allow for higher switching rates and improved switching control.

Now with reference to FIG. 14, circuitry for induction heating by the device will be described. FIG. 14 shows a simplified schematic representation of a part of an induction heating circuit 600 of the aerosol provision device 100. FIG. 14 shows a part of the induction heating circuit 600 which comprises the first inductor coil arrangement 140a for heating a first susceptor zone 190a of susceptor (or an individual susceptor 190a from a plurality of susceptors) when a varying current flows through the first inductor coil arrangement 140a. The first susceptor zone 190a is represented in FIG. 14 as having an inductive element and a resistive element to represent how the susceptor couples inductively with the first inductor coil arrangement 140a and is heated through the generation of eddy currents. It will be noted that the aerosol provision device 100 may additionally comprise one or more further inductor coil arrangements 140b-140e, which is not shown in FIG. 14. For instance, a second inductor coil arrangement 140b may also be part of the induction heating circuit 600 and is controlled to heat the second susceptor zone 190b. However, for the sake of clarity, the circuit 600 will be described with reference to those features shown in FIG. 14.

The circuit 600 comprises a first resonator section 601, the DC voltage supply 118 for supplying a DC voltage to the first resonator section 601, as well as a control arrangement for controlling the circuit 600. The first resonator section 601 comprises the first inductor coil arrangement 140a and a switching arrangement comprising a first FET 608, and the control arrangement is configured to switch the FET 608 between a first state and a second state in response to voltage conditions detected in the circuit 600, as will be described in more detail below, to operate the first inductor coil arrangement 140a. The circuit 600, with the exception of the susceptor 190, may be arranged on a PCB of the aerosol provision device 100, with the inductor coil first inductor coil arrangement 140a being connected to the PCB 122 at a first end 131a and a second end 131b.

The first resonator section 601 comprises a first capacitor 606, and a second capacitor 610, both arranged in parallel with the first inductor coil arrangement 140a such that when the first resonator section 601 is allowed to resonate an alternating current flows between the first capacitor 606 and the second capacitor 610 and through the first inductor coil arrangement 140a. As mentioned above, the first FET 608, in this example an n-channel MOSFET, is arranged to operate as a switching arrangement in the first resonator section 601.

It should be noted that in other examples, the resonator section 601 may comprise only one capacitor, for example in the position of the first capacitor 606, or at the position of the second capacitor 610. In other examples, the resonator section 601 may comprise any other number of capacitors, such as three or more capacitors. For example, either or both of the first capacitor 606 and the second capacitor 610 may be replaced by two or more capacitors arranged in parallel with one another. As will be well understood, the resonator section 601 has a resonant frequency which is dependent on the inductance L and the capacitance C of the resonator section 601. The number, type and arrangement of capacitors in the resonating section 601 may be selected based on considerations of the power levels to be used in the circuit 600 and the desired frequency of operation of the circuit 600. For example, it will be understood that individual capacitors and an arrangement of said capacitors can be considered to have an equivalent series resistance (ESR) as well as a limit on the ability of said capacitors to handle current. Such features may be taken into account when determining an arrangement of capacitors to provide the capacitance in the resonator section 601. For example, depending on desired power levels and frequency of operation, there may be an advantage to providing a plurality of capacitors in parallel, to provide higher capacitance or lower ESR. In this example, the first and second capacitors 606, 610 are both ceramic COG capacitors each having a capacitance of around 100 nF. In other examples, other types of capacitor and/or capacitors with other capacitance values, e.g. capacitors with unequal capacitance values, may be used, according to the considerations outlined in this paragraph.

The first inductor coil arrangement 140a may be configured so to act as a capacitor e.g. when the first FET 608 is “off” (that is, when it acts like an open switch so as to substantially prevent a current flowing therethrough). That is, the first inductor coil arrangement 140a may be a combined capacitor-inductor component 140a. In arrangements, the capacitance of the first inductor coil arrangement 140a or combined capacitor-inductor component 140a will contribute to that of the one or more other capacitors so as to substantially contribute to the capacitance C of the resonator section 601. In some arrangements, the resonator section 601 may only comprise the combined capacitor-inductor component 140a as the only capacitor in the resonator sector 601.

The first resonator section 601 is supplied a DC voltage by the DC voltage supply 118, which is, for example, as described above, a voltage supplied by a battery. As shown in FIG. 14, the DC voltage supply 118 comprises a positive terminal 118a and a negative terminal 118b. In one example, the DC voltage supply 118 supplies a DC voltage of around 4.2V to the first resonator section 601. In other examples, the DC voltage supply 118 may supply a voltage of 2 to 10V, or around 3 to 5V, for example.

A controller 135 is configured to control operation of the circuit 600. The controller 135 may comprise a micro-controller, e.g. a micro-processing unit (MPU), comprising a plurality of inputs and outputs. In one example, the controller 135 is an STM32L051C8T6 model MPU. In some examples, the DC voltage supply 118 provided to the circuit 600 is provided by an output from the controller 135 which itself receives power from a battery or other power source.

The positive terminal 118a of the DC voltage source 118 is electrically connected to a first node 600A. In an example, the DC voltage source 118 is connected to the node 600A via the controller 135 which receives power from the DC voltage source 118 and supplies the voltage supplied by the DC voltage source to components of the device, including the circuit 600. The first node 600A is electrically connected to a first end 606a of the first capacitor 606 and to the first end 131a of the first inductor coil arrangement 140a. The second end 131b of the first inductor coil arrangement 140a is electrically connected to a second node 600B, which in FIG. 14 is represented at two electrically equivalent points in the circuit diagram. The second node 600B is electrically connected to a drain terminal 608D of the FET 608. In this example, the second node 600B is also electrically connected to a first end 610a of the second capacitor 610. Continuing around the circuit, the source terminal 608S of the first FET 608 is electrically connected to a third node 600C. The third node 600C is electrically connected to ground 616, and in this example to a second end 610b of the second capacitor 610. The third node 600C is electrically connected via a current sense resistor 615 to a fourth node 600D, and the fourth node 600D is electrically connected to the negative terminal 118b of the DC voltage source 118, which, as with the positive terminal, in an example is supplied via the controller 135.

It should be noted that in examples where the second capacitor 610 is not present, the third node 600C may have only three electrical connections: to the first FET source terminal 608S, to ground 616 and to the current sense resistor 615.

As mentioned above, the first FET 608 acts a switching arrangement in the first resonator section 601. The first FET 608 is configurable between a first state, i.e. an ‘ON’ state and a second state, i.e. an ‘OFF’ state. As will be well understood by those skilled in the art when an n-channel FET is in an OFF state (i.e. when the appropriate control voltage is not applied to its gate) it effectively acts as a diode. In FIG. 14, the diode functionality that the first FET 608 exhibits when in its OFF state is represented by a first diode 608a. That is, when the FET 608 is in the OFF state the first diode 608a acts to largely prevent current flowing from the drain terminal 608D to the source terminal 608S but allows current to flow from the source terminal 608S to the drain terminal 608D if the diode 608a is appropriately forward biased. An n-channel FET is in an ON state when an appropriate control voltage is applied to its gate so that a conductive path exists between its drain D and source S. As such, when the first FET 608 is in the ON state, it acts like a closed switch in the first resonator section 601.

As mentioned above, the circuit 600 may be considered to comprise a first resonator section 601 and an additional control arrangement. The control arrangement comprises a comparator 618, a zero-voltage detector 621, and a flip-flop 622, and is configured to detect voltage conditions within the first resonator section 601 and to control the first FET 608 in response to the detected voltage conditions. This control of the first FET 608 by the control arrangement will now be described in more detail.

At the second node 600B there is electrically connected the zero-voltage detector 621, which is configured to detect a voltage condition, i.e. a voltage of at or near 0V with respect to a ground voltage, at a point in the circuit 600 to which the zero-voltage detector 621 is connected. The zero-voltage detector 621 is configured to output a signal to control switching of the state of the FET 608. That is, the zero-voltage detector 621 is configured to output a signal to the flip-flop 622. The flip-flop 622 is an electrical circuit which is configurable between two stable states. The flip-flop 622 is electrically connected to a first gate driver 623 which is configured to provide a voltage to the first FET gate terminal 608G dependent on the state of the flip-flop. That is, the first gate driver 623 is configured to provide an appropriate voltage to the first FET gate terminal 608G to switch the FET 608 to the ON state when the flip-flop is in one state, but is configured not to provide a voltage appropriate for maintaining the FET 608 in the ON state when the flip-flop 622 is in the other state. For example, the first gate driver 623 may be configured to provide an appropriate gate-source voltage to the first FET gate 608G to switch the FET 608 ON when the flip-flop 622 is in a state ‘1’, and the first gate driver 623 may be configured not to provide the gate-source voltage when the flip-flop 622 is in state ‘0’. The state of the flip-flop means 622 therefore controls whether the first FET 608 is on or off.

In this example, the zero-voltage detector 621 and the first gate driver 623 of the control arrangement are configured to receive respective signals 1351,1352 from the controller 135, by which signals the controller 135 can initiate and control operation of the circuit 600, as will be discussed in more detail below.

At the fourth node 600D, there is electrically connected a control voltage line 619. The control voltage line 619 is electrically connected to a fifth node 600E via a resistor 617a and the fifth node 600E is electrically connected to the voltage comparator 618—hereinafter comparator 618. The fifth node 600E is electrically connected to a positive terminal of the comparator 618. A negative terminal of the comparator 618 is connected to ground 616. In this example, the comparator 618 is configured to output a signal based on a comparison of the voltage at the fifth node 600E to ground voltage. The output signal of the comparator 618 is sent to the flip-flop 622. A control voltage 1353 is supplied, in this example from the controller 135, to the control voltage line 619 via a second resistor 617b.

As mentioned above, the comparator 618 is electrically connected to provide an output to the flip-flop 622. The flip-flop 622 is configured such that an output signal from the comparator 618 can change the state of the flip-flop 622, and thereby cause the first driver 623 to change the state of the first FET 608.

The functioning of the example circuit 600 will now be described in more detail in the context of the first resonator section 601 being activated by the controller 135 such that the first inductor coil arrangement 140a is operated to heat the first susceptor zone 190a.

To begin, the first FET 608 is configured in the OFF state, and is thus acting as a diode 608a, preventing current flowing through the first inductor coil arrangement 140a. The controller 135 initiates the operation of the circuit 600 to heat the first susceptor zone 190a by causing the FET 608 to switch from the OFF state to the ON state. In this example the controller initiates operation of the circuit 600 by providing a START signal 1351 to the zero-voltage detector 621. The flip-flop 622 is thereby caused to change states and cause the first gate driver 623 to provide a signal to the FET gate terminal 608G to thereby switch the FET to the ON state.

Once the FET 608 is switched to the ON state, what may be referred to as a self-oscillating heating cycle of the circuit 600 begins. The FET 608, now being in the ON state, acts as a closed switch allowing a DC current to begin flowing from the DC voltage source positive terminal 118a through the first inductor coil arrangement 140a and returning to the DC voltage source negative terminal 118b via the current sense resistor 615. The first inductor coil arrangement 140a opposes this initial increase in current, as is well-known, generating a back emf via Faraday's and Lenz's laws. In the ON state, the voltage between the drain terminal 608D and the source terminal 608S is substantially zero.

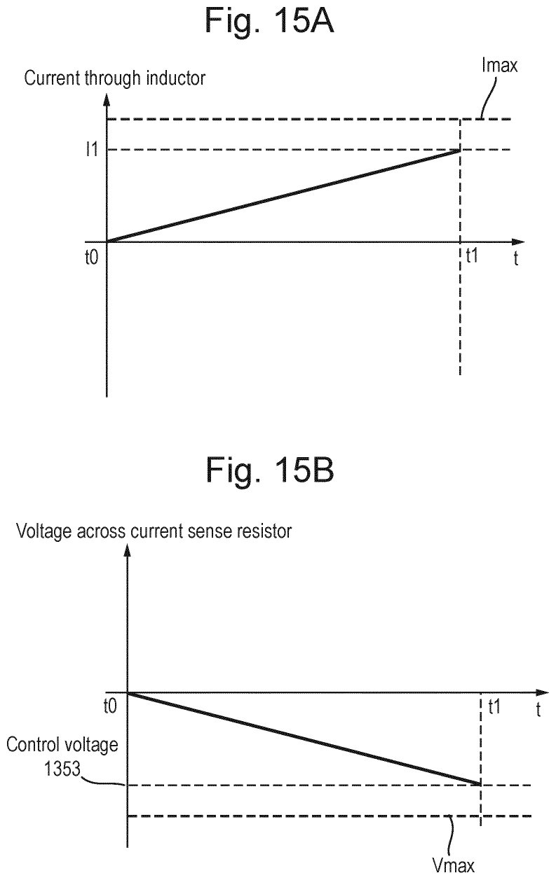

FIG. 15A shows a schematic graphical representation of the current flowing through the first inductor coil arrangement 140a against time t starting from when the FET 608 is switched on, at time t0. From time t0, a DC current begins to build up in the first inductor coil arrangement 140a from zero at a rate which is dependent on an inductance L1 of the first inductor coil arrangement 140a and a DC resistance of the circuit 600. In one example the current sense resistor 615 has a resistance of around 2 mil, while the first inductor coil arrangement 140a has a DC resistance of, 2 to 15 mil, or 4 to 10 mil, or in this example around 5.2 mΩ. This build-up of current in the inductor corresponds to the first inductor coil arrangement 140a storing magnetic energy, and the amount of magnetic energy which can be stored by the first inductor coil arrangement 140a is dependent on its inductance L1, as will be well understood.

FIG. 15B shows a simplified representation of the voltage across the current sense resistor 615 against time t, again from the time t0 when the FET 608 is turned on. Shortly after the FET 608 is turned on, a large voltage develops across the first inductor coil arrangement 140a, this being the back emf generated by the first inductor coil arrangement 140a as the inductor opposes the increase in current. At this time, therefore, the voltage across the current sense resistor 615 as shown in FIG. 15B is small, since almost all of the voltage difference provided by the DC supply 118 drops across the first inductor coil arrangement 140a. Then, as the current through the first inductor coil arrangement 140a increases and the back emf of the first inductor coil arrangement 140a decays, the voltage across the current sense resistor 615 increases. This is seen as the development of a negative voltage across the current sense resistor 615, as shown in FIG. 15B. That is, the voltage across the current sense resistor 615 becomes increasingly negative with the length of time that the FET 608 is on.

Since the increasingly negative voltage across the current sense resistor 615 corresponds with the increasing current through the first inductor coil arrangement 140a, the magnitude of the voltage across the current sense resistor 615 is indicative of the current flowing through the first inductor coil arrangement 140a. While the FET 608 remains on, the current through the first inductor coil arrangement 140a and the voltage across the current sense resistor 615 increase substantially linearly towards respective maximum values Imax, Vmax (which are dependent on the DC voltage supplied by DC supply 118 and the DC resistance of the circuit 600) with a time constant dependent on the inductance L1 and on the DC resistance of the circuit 600. It should be noted that as the current through the first inductor coil arrangement 140a is varying after time t0 some inductive heating of the susceptor 190 may occur while the DC current through the first inductor coil arrangement 140a builds up.

The circuit 600 is configured such that the amount of energy which is stored in the first inductor coil arrangement 140a in the time during which the FET 608 is switched on, is determined by the control arrangement and can be controlled by the controller 135. That is, the controller 135 controls an amount of DC current (and thus an amount of magnetic energy) allowed to build up in the first inductor coil arrangement 140a, as will now be described.

As described above, the control voltage 1353 is applied to the control voltage line 619. In this example, the control voltage 1353 is a positive voltage and the voltage input to the positive terminal of the comparator 618 (i.e. the voltage at the fifth node 600E) at any one time is dependent on the value of control voltage 1353 and the voltage at the fourth node 600D. When the negative voltage across the current sense resistor 615 reaches a particular value, it cancels, at the fifth node 600E, the positive control voltage 1353 and gives a voltage of 0 V (i.e. ground voltage) at the fifth node 600E. In this example, the resistor 617a has a resistance of 2 mΩ. The resistor 617b represents an effective resistance to the controller 135 of 70 kΩ. The voltage at the fifth node 600E reaches 0V when the negative voltage across the current sense resistor 615 has the same magnitude as the control voltage 1353.

The comparator 618 is configured to compare the voltage at its positive terminal to the voltage of ground 616, connected to its negative terminal, and output a signal as a result. In one example the comparator is a standard component FAN156, as may be obtained from On-Semiconductor. Accordingly, when the voltage at fifth node 600E reaches 0V, the comparator 618 receives a 0V signal at its positive terminal, and the result of the comparison by the comparator 618 is that the voltage at the positive terminal is equal to the voltage at the negative terminal. The comparator 618 consequently outputs a signal to the flip-flop 622 and causes the FET 608 to be switched off. As such, switching off of the FET 608 is dependent on a voltage condition detected in the circuit 600. Namely, in this example, when the comparator 618 detects by comparison of the voltage across its terminals that a negative voltage across the current sense resistor 615 has reached the same magnitude as the control voltage 1353, which occurs at time t1, the FET 608 is switched off. In FIG. 15A, the DC current flowing through the first inductor coil arrangement 140a at time t1 when the FET 608 is switched off is labelled Il.

When the FET 608 is turned off, at time t1, the FET 608 switches from acting like a closed switch to acting like a diode 608a in the resonator section 601, and for the purposes of supply from the DC supply 118 effectively acting like an open switch. At time t1 the path of the DC current through the first inductor coil arrangement 140a to ground 616 is interrupted by the FET 608. This triggers the current flowing in the first inductor coil arrangement 140a to drop off (this is not shown in FIG. 15A), and the first inductor coil arrangement 140a opposes this change in current by generating an induced voltage. Accordingly, current begins oscillating back and forth between the first inductor coil arrangement 140a and the capacitors 606, 608 at the resonant frequency of the first resonator section 601.

Similarly, the voltage across the first inductor coil arrangement 140a and thereby between the first FET drain 608D and source 608S terminals begins to oscillate at the resonant frequency of the first resonator section 601. As the current through and voltage across the inductor 124 begin to oscillate, the susceptor 190 is inductively heated. Switching the FET 608 to the OFF state, therefore acts to release the magnetic energy stored in the first inductor coil arrangement 140a at time t1 to heat the susceptor 190.

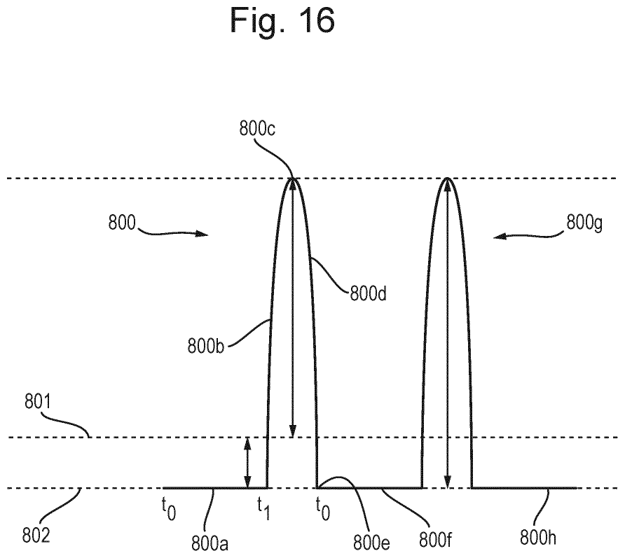

FIG. 16 shows a trace 800 of the voltage across the first FET 608, starting from the FET 608 being in the ON state from time t0 to t1. Over the time illustrated in FIG. 16 the first FET 608 is turned off and on twice.

The voltage trace 800 comprises a first section 800a between times t0 and t1 when the first FET 608 is ON, and a second section 800b to 800d when the first FET 608 is switched off. At 800e the FET 608 is switched on again, and a third section 800f which is equivalent to the first section 800a begins while the first FET 608 remains on and the above-described process of building up of DC current through the inductor 124 repeats. FIG. 16 also shows a fourth section 800g when the first FET 608 is switched off again to allow oscillation of the voltage across the FET 608, and a fifth section 800h when the first FET 608 is subsequently switched on again.

The voltage across the first FET 608 is zero when the first FET 608 is on in sections 800a, 800f and 800h. When the first FET 608 is turned off as indicated by section 800b to 800d and also by section 800g, the first inductor coil arrangement 140a uses the energy stored in its magnetic field (which magnetic field was the result of the DC current built up when the first FET 608 was on) to induce a voltage that opposes a drop in the current flowing through the first inductor coil arrangement 140a as a result of the first FET 608 being off. The voltage induced in the first inductor coil arrangement 140a causes a corresponding variation in voltage across the first FET 608. During this variation in voltage, the first inductor coil arrangement 140a and the capacitors 606, 610 begin to resonate with each other with a sinusoidal waveform. The voltage shown by voltage trace 800 initially increases (see for example 800b) as the induced voltage in the first inductor coil arrangement 140a increases to oppose a drop in current due to the first FET 608 being off, reaches a peak (see for example 800c) and then, as the energy stored in the magnetic field of the first inductor coil arrangement 140a diminishes, decreases back to zero (see for example 800d).

The varying voltage 800b to 800d and 800g produces a corresponding varying current (not shown) and, since during the off time of the first FET 608, the capacitors 606, 610 and the first inductor coil arrangement 140a act as a resonant LC circuit, the total impedance of the combination of the first inductor coil arrangement 140a and capacitors 606, 610 is at a minimum during this time. It will therefore be understood that the maximum magnitude of the varying current flowing through the first inductor coil arrangement 140a will be relatively large. This relatively large varying current accordingly causes a relatively large varying magnetic field in the first inductor coil arrangement 140a which causes the susceptor 190 to generate heat. The time period over which the voltage across the first FET 608 varies as indicated by section 800b to 800d and by section 800g in this example depends on the resonant frequency of the first resonator section 601.

Referring now to FIGS. 14 and 16, the circuit 600 is configured such that when the first FET 608 is off and the voltage across the first FET 608 decreases back towards 0V, the zero-voltage detector 621 detects this voltage condition and outputs a signal to the flip-flop 622 which causes the first FET 608 to be switched back to the ON state. That is, in response to this voltage condition detected within the first resonator section 601, the FET 608 is switched from the OFF state to the ON state. The zero-voltage detector 621 may be considered to detect a voltage condition indicative that a given proportion of a cycle of current oscillation between the inductive element and the capacitive element has been completed since the FET 608 was switched off. That is, the zero-voltage detector 621 detects that a half-cycle of current (and voltage) oscillation at the resonant frequency of the first resonator section 601 has been completed by the zero-voltage detector 621 detecting that the voltage across the FET 608 has returned to 0V or nearly 0V.

In some examples, the zero-voltage detector 621 may detect when the voltage across the first FET 608 has returned to at or below a voltage level 801 and as such may output a signal to cause switching of the state of the FET 608 before the voltage across the FET 608 reaches exactly 0V. As is illustrated by FIG. 16, the operation of the zero-voltage detector 621 curtails oscillations of the voltage in the resonator section 601 after one half-cycle and thus results in a substantially half-sine wave voltage profile across the first FET 608.

When the first FET 608 is switched back on, at point 800e, a DC current driven by the DC source 118 again builds up through the first inductor coil arrangement 140a. The first inductor coil arrangement 140a may then again store energy in the form of a magnetic field to be released when the first FET 608 is next switched off to initiate resonance within the first resonator section 601. As the first FET 608 is repeatedly switched on and off in this way, the above described process is continuously repeated to heat the susceptor 190.

It should be noted that the above described building up of current through the first inductor coil arrangement 140a described with reference to FIGS. 15A and 15B occurs both when the FET 608 is turned on initially in response to a START signal 1351 from the controller 135 and when the FET 608 is switched on subsequently by a zero-voltage condition detected by the zero-voltage detector 621. In the first instance, in response to the START signal 1351, the current in the first inductor coil arrangement 140a builds up substantially linearly from 0. In the second instance, when the FET 608 is turned back on in response to a detected zero voltage condition at point 800e, some excess current is circulating in the circuit 600 (e.g. from previous cycles of switching on and off of the FET 608). As the FET 608 is turned back on following the detection of a zero-voltage condition, the recirculating current produces an initial negative current through the FET 608. Then, while the FET 608 remains on, the current through the FET 608 and first inductor coil arrangement 140a builds up, substantially linearly, from the initial negative current value produced by the recirculating current. As the current through the first inductor coil arrangement 140a builds up, the voltage across the current sense resistor 615 correspondingly becomes increasingly negative, in the manner described above.

In examples, switching on and off of the FET 608 may occur at a frequency of around 100 kHz to 2 MHz, or around 500 kHz to 1 MHz, or around 300 kHz. The frequency at which the switching on and off of the FET 608 occurs is dependent upon the inductance L, the capacitance C, the DC supply voltage supplied by the supply 618 and further upon a degree to which current continues recirculating through the resonator section 601 and the loading effect of the susceptor 190. For example, where the DC supply voltage equals 3.6 V, the inductance of the inductor 124 is 140 nH, and the capacitance of the resonator section 601 is 100 nF, the time for which the FET 608 remains on may be around 2700 ns and the time for a half-cycle of oscillation to complete when the FET 608 is off may be around 675 ns. These values correspond to a power of around 20 W being supplied from the DC voltage supply 118 to the resonator section 601. The above value of the time for which the FET 608 remains on is affected by the amount of current which recirculates in the circuit, since as described above, this recirculating current causes an initial negative current through the inductor upon switching on of the FET 608. It should also be noted that the time for the current to build up to the value which causes switching off of the FET 608 is also at least in part dependent on the resistance of the first inductor coil arrangement 140a, however, this has a relatively minor effect on the time when compared to the effect of the inductance of the resonator section 601. The time for a half-cycle of oscillation to complete (of in this example 675 ns) is dependent on the resonant frequency of the resonator section 601 which is affected not only by the values of inductance and capacitance of the inductor 124 and capacitors 606,610 respectively, but also by the effective resistance provided by loading the inductor 124 with the susceptor 190.

Thus far, the circuit 600 has been described in terms of its operation to heat the susceptor 190 by one inductor, the first inductor coil arrangement 140a, and thus only a part of the circuit 600 used by the aerosol provision device 100 has been described. However, as described above in relation to FIG. 1, the aerosol provision device 100 may also comprise one or more further inductor coil arrangements 140b-140e for heating the one or more further zones of the susceptor 190 (or the one or more further susceptors of the plurality of susceptors).

As will be understood, in other arrangements, the first inductor coil arrangement 140a and one or more capacitors may be driven by an AC power source, and may be arranged in series or in parallel, so as to drive a varying electrical current through the first inductor coil arrangement 140a to produce a varying magnetic field to thereby heat the corresponding susceptor portion.

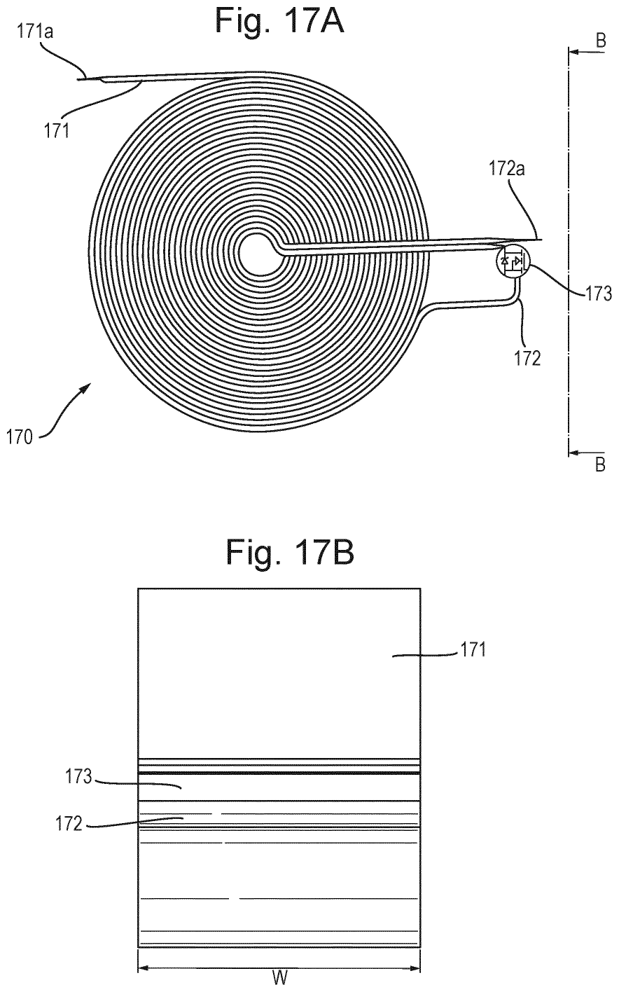

Turning now to FIG. 17A, there is shown an inductor bifilar ribbon coil arrangement 170 according to an arrangement. FIG. 17B shows an edge-on view of the inductor bifilar ribbon coil arrangement 170 (e.g. along line B-B in FIG. 17A). The inductor bifilar ribbon coil arrangement 170 may be used to create a varying magnetic field to thereby heat at least a portion of a susceptor in the manner described above. The inductor coil arrangement 170 contains a first winding or coil 171 and a second winding or coil 172 which is closely spaced and parallel with the first winding 171. As shown, the first 171 and second 172 windings are in the form of thin and wide ribbons, with a width of W. Accordingly, the capacitive linking of the wires is substantially increased due to the increase in face-to-face surface area of the two windings 171,172.

The two windings are bonded by a short electrically conducting linking portion 173 such that current flow through the two windings is maintained in the same direction and that there is a low phase shift between the windings 171,172. Accordingly, the inductive performance of the an inductor bifilar ribbon coil arrangement 170 is improved in a similar way to the Tesla bifilar coil arrangement 70 of FIG. 7. However, relative to the arrangement of FIG. 7, the capacitance of the inductor bifilar ribbon coil arrangement 170 is substantially increased.

In some arrangements, the inductor bifilar ribbon coil arrangement 170 is a combined capacitor-inductor component 170, as described above. For instance, the inductor bifilar ribbon coil arrangement 170 may comprise a switching mechanism as the short electrically conducting linking portion 173 (for instance a MOSFET as described in relation to FIG. 14). Accordingly, if the free end 171a of the first winding 171 and the free end 172a of the second winding 172 are respectively connected to opposite terminals of a power supply (e.g. a DC power supply similar to the power supply 118 in FIG. 16), then with the switching mechanism 173 in the open position the combined capacitor-inductor component 170 will act as a capacitor, whereas with the switching mechanism 173 in the closed position the combined capacitor-inductor component 170 will act as an inductor.

In arrangements, the windings 171,172 may be separated by an insulator positioned there-between. That is, the insulator may be in the form of a ribbon of similar length interwoven between the windings 171,172. The insulator may be substantially thin such that the face-to-face conducting surfaces of the windings are positioned close together, further enhancing the capacitance of the component 170.

As will be appreciated, this may save space within the electronic circuitry of the aerosol provision device 100.

In arrangements, the combined capacitor-inductor component 170 may be used in an LC resonator circuit such as resonator section 601 shown in FIG. 14. Accordingly, the LC resonator circuit comprising only the combined capacitor-inductor component 170 for providing inductance L and capacitance C may operate at a resonant frequency of around 20 MHz. However, by decreasing the thickness of an insulator separating the windings 171, 172 and increasing the width W, the LC circuit may operate at resonant frequencies of: less than 20 MHz, such as between and 20 MHz, or between 1 and 10 MHz.

It will be understood that one or more further capacitors may also be provided.

Referring again to FIG. 1, the aerosol provision device 100 may comprise a temperature sensor (not shown) for sensing a temperature of the heating chamber 110, the susceptor 190 or the article 10. The temperature sensor may be communicatively connected to the controller 135, so that the controller 135 is able to monitor the temperature of the heating chamber 110, the susceptor 190 or the article 10, respectively, on the basis of information output by the temperature sensor. In other examples, the temperature may be sensed and monitored by measuring electrical characteristics of the system, e.g., the change in current within the heating units 140a-140e. On the basis of one or more signals received from the temperature sensor, the controller 135 may cause a characteristic of the varying or alternating electrical current to be adjusted as necessary, in order to ensure that the temperature of the heating chamber 110, the susceptor 190 or the article 10, respectively, remains within a predetermined temperature range. The characteristic may be, for example, amplitude or frequency or duty cycle. Within the predetermined temperature range, in use the aerosol generating material 11 within the article 10 located in the heating chamber 110 is heated sufficiently to volatilize at least one component of the aerosol generating material 11 without combusting the aerosol generating material 11. Accordingly, the controller 135, and the aerosol provision device 100 as a whole, is arranged to heat the aerosol generating material 11 to volatilize the at least one component of the aerosol generating material 11 without combusting the aerosol generating material 11. The temperature range may be between about 50° C. and about 350° C., such as between about 100° C. and about 300° C., or between about 150° C. and about 280° C. In other examples, the temperature range may be other than one of these ranges. In some examples, the upper limit of the temperature range could be greater than 350° C. In some examples, the temperature sensor may be omitted.

It will be understood that, for a given duration of heating session, the greater the number of heating units and associated portions of the aerosol generating material 11 there are, the greater the opportunity to generate aerosol from “fresh” or unspent portions of the aerosol generating material 11 extending along a given axial length. Alternatively, for a given duration of heating each portion of the aerosol generating material 11, the greater the number of heating units and associated portions of the aerosol generating material 11 there are, the longer the heating session may be. It should be appreciated that the duration for which an individual heating unit may be activated can be adjusted (e.g. shortened) to adjust (e.g. reduce) the overall heating session, and at the same time the power supplied to the heating element may be adjusted (e.g. increased) to reach the operational temperature more quickly.

In some arrangements, the aerosol provision device is a hybrid system to generate aerosol using a combination of aerosol generating materials, one or a plurality of which may be heated. Each of the aerosol generating materials may be, for example, in the form of a solid, liquid or gel and may or may not contain nicotine. In some arrangements, the hybrid system comprises a liquid or gel aerosol generating material and a solid aerosol generating material. The solid aerosol generating material may comprise, for example, tobacco or a non-tobacco product.

Aerosol generating material may, for example, be in the form of a solid, liquid or gel which may or may not contain nicotine and/or flavorants. In some arrangements, the article 10 is a consumable article or an article for use with an aerosol provision device. Once all, or substantially all, of the volatilizable component(s) of the aerosol generating material 11 in the article 10 has/have been spent, the user may remove the article 10 from the heating zone 110 of the aerosol provision device 100 and dispose of the article 10. The user may subsequently re-use the aerosol provision device 100 with another of the articles 10. However, in other respective arrangements, the article 10 may be non-consumable relative to the aerosol generator 130. That is, aerosol generator 130 and the article 10 may be disposed of together once the volatilizable component(s) of the aerosol generating material 11 has/have been spent.

In some arrangements, the article 10 is sold, supplied or otherwise provided separately from the aerosol provision device 100 with which the article 10 is usable. However, in some arrangements, the aerosol provision device 100 and one or more of the articles 10 may be provided together as a system, such as a kit or an assembly, possibly with additional components, such as cleaning utensils.

The aerosol provision device, aerosol provision system and the inductor coil according to various arrangements find particular utility when generating aerosol from a substantially flat article. The substantially flat article may be provided in either an array or a circular format. Other arrangements are also contemplated.

In some arrangements e.g. wherein the substantially flat article is provided in the form of an array, multiple heating regions may be provided. For example, according to an arrangement one heating region may be provided per portion, pixel or portion of the article.

In other arrangements, the substantially flat article may be rotated such that a segment of the article is heated by a similar shaped heater. According to this arrangement a single heating region may be provided.

In particular, the inductor arrangement according to various arrangements may be provided as part of an aerosol provision device which is arranged to heat-not-burn an article as part of an aerosol provision system. In particular, the article may comprise a plurality of discrete portions of aerosol generating material.

In some arrangements, the aerosol generating material is formed as a sheet. In some cases, the aerosol generating material sheet may be incorporated into the assembly or article in sheet form, for example the plurality of discrete portions may be a plurality of sheets. The aerosol generating material sheets may be incorporated as a planar sheets, as a gathered or bunched sheets, as a crimped sheets, or as rolled sheets (i.e. in the form of a tube). In some such cases, the aerosol generating material of these arrangements may be included in an aerosol generating article/assembly as sheets, such as sheets circumscribing a rod of aerosol generating material (e.g. tobacco). For example, the aerosol generating material sheets may be formed on a wrapping paper which circumscribes an aerosol generating material such as tobacco. In other cases, the sheets may be shredded and then incorporated into the assembly, suitably mixed into an aerosol generating material such as cut rag tobacco.

The article may comprise a support on which the aerosol generating material is provided. The support functions as a support on which the aerosol generating material forms, easing manufacture. The support may provide tensile strength to the aerosol generating material, easing handling. In some cases, the plurality of discrete portions of aerosol generating material are deposited on such a support. In some cases, the plurality of discrete portions of aerosol generating material is deposited on such a support. In some cases, the discrete portions of aerosol generating material are deposited on such a support such that each discrete portion may be heated and aerosolized separately.

In some cases, the support may be formed from materials selected from metal foil, paper, carbon paper, greaseproof paper, ceramic, carbon allotropes such as graphite and graphene, plastic, cardboard, wood or combinations thereof. In some cases, the support may comprise or consist of a tobacco material, such as a sheet of reconstituted tobacco. In some cases, the support may be formed from materials selected from metal foil, paper, cardboard, wood or combinations thereof. In some cases, the support itself be a laminate structure comprising layers of materials selected from the preceding lists. In some cases, the support may also function as a flavorant carrier. For example, the support may be impregnated with a flavorant or with tobacco extract.

In some cases, the support is formed from or comprises metal foil, such as aluminum foil. A metallic support may allow for better conduction of thermal energy to the aerosol generating material. Additionally, or alternatively, a metal foil may function as a susceptor in an induction heating system. In particular arrangements, the support comprises a metal foil layer and a support layer, such as cardboard. In these arrangements, the metal foil layer may have a thickness of less than 20 μm, such as from about 1 μm to about 10 μm, suitably about 5 μm.

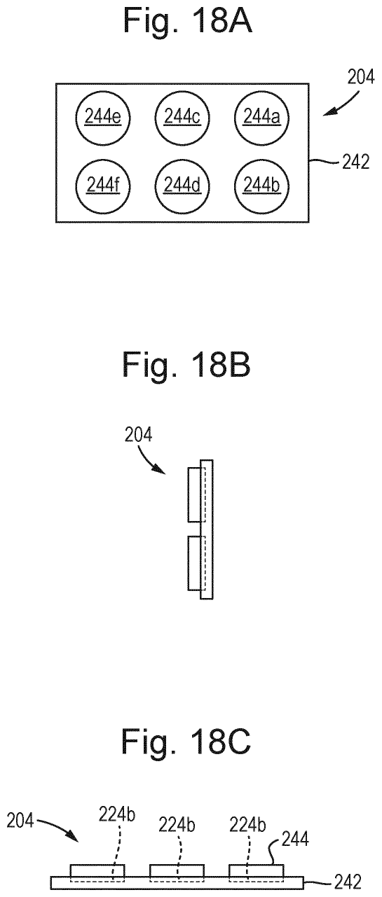

Reference is made to FIGS. 18A-18C. According to an arrangement a consumable or aerosol generating article 204 for use with an aerosol provision device may be provided wherein the aerosol generating article 204 comprises a planar aerosol generating article 204. The planar aerosol generating article 204 may comprise a carrier component 242, one or more susceptor elements 224b and one or more portions of aerosol generating material 244a-f as shown and described in more detail with reference to FIGS. 18A-18C.

FIG. 18A shows a top-down view of an aerosol generating article 204 according to an arrangement, FIG. 18B shows an end-on view along the longitudinal (length) axis of the aerosol generating article 204 according to an arrangement and FIG. 18C shows a side-on view along the width axis of the aerosol generating article 204 according to an arrangement.

The one or more susceptor elements 224b may be formed from aluminum foil, although it should be appreciated that other metallic and/or electrically conductive materials may be used in other implementations. As seen in FIG. 18C, the carrier component 242 may comprise a number of susceptor elements 224b which correspond in size and location to the discrete portions of aerosol generating material 244a-f disposed on the surface of the carrier component 242. That is, the susceptor elements 224b may have a similar width and length to the discrete portions of aerosol generating material 244a-f.

The susceptor elements 224b are shown embedded in the carrier component 242. However, in other arrangements, the susceptor elements 224b may be placed or located on the surface of the carrier component 242. According to another arrangement a susceptor may be provided as a single layer substantially covering the carrier component 244. According to an arrangement the aerosol generating article 204 may comprise a substrate or support layer, a single layer of aluminum foil which acts as a susceptor and one or more regions of aerosol generating material 244 deposited upon the aluminum foil susceptor layer.

According to an arrangement an array of induction heating coils may be provided to energize the discrete portions of aerosol generating material 244. However, according to other arrangements a single induction coil may be provided and the aerosol generating article 204 may be configured to move relative to the single induction coil. Accordingly, there may be fewer induction coils than discrete portions of aerosol generating material 244 provided on the carrier component 242 of the aerosol generating article 204, such that relative movement of the aerosol generating article 204 and induction coil(s) is required in order to be able to individually energize each of the discrete portions of aerosol generating material 244.

Alternatively, a single induction coil may be provided and the aerosol generating article 204 may be rotated relative to the single induction coil.

Although the above has described implementations where discrete, spatially distinct portions of aerosol generating material 244 are deposited on a carrier component 242, it should be appreciated that in other implementations the aerosol generating material 244 may not be provided in discrete, spatially distinct portions but instead be provided as a continuous sheet, film or layer of aerosol generating material 244. In these implementations, certain regions of the sheet of aerosol generating material 244 may be selectively heated to generate aerosol in broadly the same manner as described above. In particular, a region (corresponding to a portion of aerosol generating material) may be defined on the continuous sheet of aerosol generating material 244 based on the dimensions of the one or more inductive heating elements.

According to various arrangements the aerosol generating article 204 may comprise a disc shaped or circular article.

In order to address various issues and advance the art, the entirety of this disclosure shows by way of illustration and example various embodiments in which that which is claimed may be practiced and which provide for superior heating elements for use with apparatus for heating aerosolizable material, methods of forming a heating element for use with apparatus for heating aerosolizable material to volatilize at least one component of the aerosolizable material, and systems comprising apparatus for heating aerosolizable material to volatilize at least one component of the aerosolizable material and a heating element heatable by such apparatus. The advantages and features of the disclosure are of a representative sample of embodiments only, and are not exhaustive and/or exclusive. They are presented only to assist in understanding and teach the claimed and otherwise disclosed features. It is to be understood that advantages, embodiments, examples, functions, features, structures and/or other aspects of the disclosure are not to be considered limitations on the disclosure as defined by the claims or limitations on equivalents to the claims, and that other embodiments may be utilized and modifications may be made without departing from the scope and/or spirit of the disclosure. Various embodiments may suitably comprise, consist of, or consist in essence of, various combinations of the disclosed elements, components, features, parts, steps, means, etc. The disclosure may include other inventions not presently claimed, but which may be claimed in future.

1. An aerosol provision device comprising:
an aerosol generator having a layered inductor arrangement, wherein the layered inductor arrangement comprises a plurality of layers.

2. The aerosol provision device as claimed in claim 1, wherein the layered inductor arrangement comprises one or more electrically-conductive elements, each electrically-conductive element comprising:
a first layer comprising an electrically-conductive first portion;
a second layer comprising an electrically-conductive second portion, wherein the second layer is spaced from the first layer along a first direction by a first spacing; and
a third layer comprising an electrically-conductive third portion, wherein the third layer that is spaced from the second layer along a second direction by a second spacing.

3. The aerosol provision device as claimed in claim 2, wherein each layered inductor arrangement comprises:
a first electrically-conductive connector that electrically connects the first portion to the second portion; and
a second electrically-conductive connector that electrically connects the second portion to the third portion.

4. The aerosol provision device as claimed in claim 1, wherein the layered inductor arrangement comprises layers disposed on a printed circuit board (PCB).

5. The aerosol provision device as claimed in claim 1, wherein the layered inductor arrangement comprises layers formed by at least one of: laser direct structuring; laser active plating; or sinter ceramics.

6. The aerosol provision device comprising:
an aerosol generator having a layered inductor arrangement, wherein the layered inductor arrangement comprises:
two or more layers; and
a bifilar coil.

7. The aerosol provision device as claimed in claim 6, wherein the bifilar coil comprises a first concentric inductor and a second concentric inductor, wherein a first layer comprises the first concentric inductor and a second layer comprises the second concentric inductor.

8. The aerosol provision device as claimed in claim 7, wherein the bifilar coil comprises an electrically-conductive linking portion, the electrically-conductive linking portion connecting the first concentric inductor and the second concentric inductor.

9. An aerosol provision device comprising:
an aerosol generator having a trapezoid shaped inductor arrangement.

10. The aerosol provision device as claimed in claim 9, wherein the trapezoid shaped inductor arrangement comprises an electrically-conducting track, the electrically-conducting track forming an inductor coil in a substantially trapezoidal shape, wherein the substantially trapezoidal shape comprises:
a first angled side;
a second angled side;
a long side; and
a short side shorter in length than the long side.

11. The aerosol provision device as claimed in claim 1, wherein the aerosol generator comprises one or more inductor arrangements, wherein the one or more inductor arrangements are arranged to generate a varying magnetic field, and wherein one or more susceptors are arranged to become heated by the varying magnetic field.

12. An aerosol provision system comprising:
the aerosol provision device as claimed in claim 1; and
an article for use with the aerosol provision device.

13. The aerosol provision system as claimed in claim 12, wherein the article includes one or more susceptor elements.

14. The aerosol provision system as claimed in claim 12, wherein the article comprises aerosol generating material.

15. A method of generating an aerosol comprising:
providing the aerosol provision device as claimed in claim 1;
inserting an article comprising aerosol generating material into the aerosol provision device; and
energizing the aerosol generator.

16. A method of making an aerosol provision device comprising:
providing an aerosol generator having a layered inductor arrangement, wherein the layered inductor arrangement comprises a plurality of layers.

17. A method of making an aerosol provision device comprising:
providing an aerosol generator having a layered inductor arrangement, wherein the layered inductor arrangement comprises:
two or more layers; and
a bifilar coil.

18. A method of making an aerosol provision device comprising:
providing an aerosol generator having a trapezoid shaped inductor arrangement.

19. An aerosol provision device comprising:
an aerosol generator having a layered inductor arrangement, wherein the layered inductor arrangement comprises:
a first layer comprising an electrically-conductive first portion; and
a second layer comprising an electrically-conductive second portion.

20. The aerosol provision device as claimed in claim 19, wherein the electrically-conductive first portion comprises a circular spiral.

21. The aerosol provision device as claimed in claim 19, wherein the electrically-conductive second portion comprises a circular spiral.

22. The aerosol provision device as claimed in claim 19, further comprising at least a third layer comprising an electrically-conductive third portion, wherein the electrically-conductive third portion comprises a circular spiral.
